(19) United States
(12) Patent Application Publication
(10) Pub. No.: US 2023/0370958 A1
(43) Pub. Date: Nov. 16, 2023

(54) Control and Data Splitting for Communication Using Reflective Surfaces

(71) Applicant: Apple Inc., Cupertino, CA (US)

(72) Inventors: Bertram R. Gunzelmann, Koenigsbrunn (DE); Stefan Meyer, Hoechstadt (DE); Jan Ellenbeck, Gruenwald (DE)

(21) Appl. No.: 18/186,889

(22) Filed: Mar. 20, 2023

Related U.S. Application Data
(60) Provisional application No. 63/341,748, filed on May 13, 2022.

(51) Int. Cl. H04W 48/16; H04W 36/06; H04B 7/155

(52) U.S. Cl. CPC H04W 48/16; H04W 36/06; H04B 7/15507

(57) ABSTRACT

A user equipment (UE) device may communicate with a wireless access point (AP) using wireless signals transmitted using a data radio access technology (RAT) via reflection off a reconfigurable intelligent surface (RIS) at frequencies greater than about 100 GHz. A control RAT may be used to convey control signals between the AP, UE device, and RIS. The control signals and the control RAT and the data transfer RAT may split procedures used to perform discovery, to establish an initial configuration of the UE device, AP, and/or RIS, and to update the configuration of the UE device, the AP, and/or the RIS while tracking the UE device over time. The control RAT may allow for control operations without requiring line-of-sight and may allow the RIS to minimize its power consumption and cost.

This application claims the benefit of U.S. Provisional Patent Application No. 63/341,748, filed May 13, 2022, which is hereby incorporated by reference herein in its entirety.

### FIELD

This disclosure relates generally to electronic devices and, more particularly, to electronic devices with wireless circuitry.

### BACKGROUND

Electronic devices are often provided with wireless capabilities. An electronic device with wireless capabilities has wireless circuitry that includes one or more antennas. The wireless circuitry is used to perform communications using radio-frequency signals conveyed by the antennas.

As software applications on electronic devices become more data-intensive over time, demand has grown for electronic devices that support wireless communications at higher data rates. However, the maximum data rate supported by electronic devices is limited by the frequency of the radio-frequency signals. As the frequency of the radio-frequency signals increases, it can become increasingly difficult to perform satisfactory wireless communications because the signals become subject to significant over-the-air attenuation and typically require line-of-sight.

### SUMMARY

A user equipment (UE) device may communicate with a wireless access point (AP) using wireless signals transmitted using a data transfer radio access technology (RAT) at frequencies greater than about 100 GHz. When a line-of-sight path between the UE device and the AP is blocked, a reconfigurable intelligent surface (RIS) may be used to reflect the wireless signals of the data transfer RAT between the UE device and the AP. The RIS may also be used to reflect the wireless signals when reflection via the RIS exhibits superior propagation conditions than the line-of-sight path.

Control signals may be conveyed between the UE device, the AP, and the RIS using the control RAT. The AP or the UE device may control the RIS over the control RAT. The control RAT may include ultrawideband (UWB), a cellular telephone RAT, Wi-Fi, Bluetooth, or other RATs that are less expensive to implement than the data transfer RAT. The control signals and the control RAT and the data transfer RAT may split procedures used to perform discovery, to establish an initial configuration of the UE device, AP, and/or RIS, and to update the configuration of the UE device, the AP, and/or the RIS while tracking the UE device over time. The control RAT may, for example, be used to perform RIS discovery, to perform UE discovery, to perform timing synchronization, to exchange device capabilities, to control how the RIS reflects signals transmitted using the second RAT, to write or update a codebook of the RIS, to perform codebook switching, to update signal beams of the AP and/or UE, and/or to perform any other desired control functions. During discovery, configuration, and tracking, the data transfer RAT may be used to convey reference signals or radar signals that are measured during one or more beam sweeps performed by the RIS, UE device, and/or AP. The control RAT may be used to coordinate the beam sweeps. The control RAT may allow for control operations without requiring line-of-sight and may allow the RIS to minimize its power consumption and cost.

An aspect of the disclosure provides a method of operating a wireless access point to communicate with a user equipment (UE) device via a reconfigurable intelligent surface (RIS), the RIS having a first array of antenna elements that is configurable to exhibit different sets of reflection coefficients. The method can include transmitting, using a transmitter and a first radio access technology (RAT), an instruction to the RIS that configures the first array of antenna elements at the RIS to exhibit a selected set of reflection coefficients from the different sets of reflection coefficients. The method can include transmitting, using a second array of antenna elements at the wireless access point and a second RAT that is different from the first RAT, radio-frequency signals to the UE device via reflection off the RIS concurrent with the first array of antenna elements exhibiting the selected set of reflection coefficients.

An aspect of the disclosure provides a method of operating a user equipment (UE) device to communicate with a wireless access point via a reconfigurable intelligent surface (RIS), the RIS having a first array of antenna elements. The method can include transmitting, using a transmitter and a first radio access technology (RAT), a control signal that configures a response of the RIS in using the first array of antenna elements to reflect electromagnetic energy. The method can include conveying, using a second array of antenna elements at the UE device and a second RAT that is different from the first RAT, radio-frequency signals with the wireless access point via reflection off the RIS.

An aspect of the disclosure provides a method of operating a reconfigurable intelligent surface (RIS) to reflect radio-frequency signals between a first electronic device and a second electronic device. The method can include receiving, using a receiver and a first radio access technology (RAT), a control signal transmitted by the first electronic device. The method can include configuring, using one or more processors, an array of antenna elements to exhibit a set of reflection coefficients based on the control signal. The method can include reflecting, using the array of antenna elements, radio-frequency signals between the first electronic device and the second electronic device while the array of antenna elements exhibits the set of reflection coefficients, the radio-frequency signals being of a second RAT that is different from the first RAT.

### BRIEF DESCRIPTION OF THE DRAWINGS

FIG. 1 is a schematic block diagram of an illustrative wireless access point and user equipment device that wirelessly communicate at frequencies greater than about 100 GHz in accordance with some embodiments.

FIG. 2 is a top view of an illustrative antenna that transmits wireless signals at frequencies greater than about 100 GHz based on optical local oscillator (LO) signals in accordance with some embodiments.

FIG. 3 is a top view showing how an illustrative antenna of the type shown in FIG. 2 may convert received wireless signals at frequencies greater than about 100 GHz into intermediate frequency signals based on optical LO signals in accordance with some embodiments.

FIG. 4 is a top view showing how multiple antennas of the type shown in FIGS. 2 and 3 may be stacked to cover multiple polarizations in accordance with some embodiments.

FIG. 5 is a top view showing how stacked antennas of the type shown in FIG. 4 may be integrated into a phased antenna array for conveying wireless signals at frequencies greater than about 100 GHz within a corresponding signal beam.

FIG. 6 is a circuit diagram of illustrative wireless circuitry having an antenna that transmits wireless signals at frequencies greater than about 100 GHz and that receives wireless signals at frequencies greater than about 100 GHz for conversion to intermediate frequencies and then to the optical domain in accordance with some embodiments.

FIG. 7 is a circuit diagram of an illustrative phased antenna array that conveys wireless signals at frequencies greater than about 100 GHz within a corresponding signal beam in accordance with some embodiments.

FIG. 8 is a diagram showing how an illustrative reconfigurable intelligent surface (RIS) may reflect wireless signals at frequencies greater than about 100 GHz between a wireless access point and a user equipment device in accordance with some embodiments.

FIG. 9 is a diagram showing how an illustrative RIS may include an array of antenna elements configured to passively reflect wireless signals at frequencies greater than about 100 GHz in different directions in accordance with some embodiments.

FIG. 10 is a diagram showing how an illustrative wireless access point, RIS, and user equipment device may communicate using both a data transfer radio access technology (RAT) and a control RAT in accordance with some embodiments.

FIG. 11 is a flow chart of illustrative operations that may be performed by a UE device and a wireless access point to communicate via a RIS while splitting procedures between the control RAT and the data transfer RAT in accordance with some embodiments.

FIG. 12 is a table of illustrative procedures that may be performed using the control RAT or the data transfer RAT in accordance with some embodiments.

FIG. 13 is a flow chart of illustrative operations involved in using the control RAT and the data transfer RAT to establish and maintain communications between a UE device and a wireless access point via a RIS in accordance with some embodiments.

### DETAILED DESCRIPTION

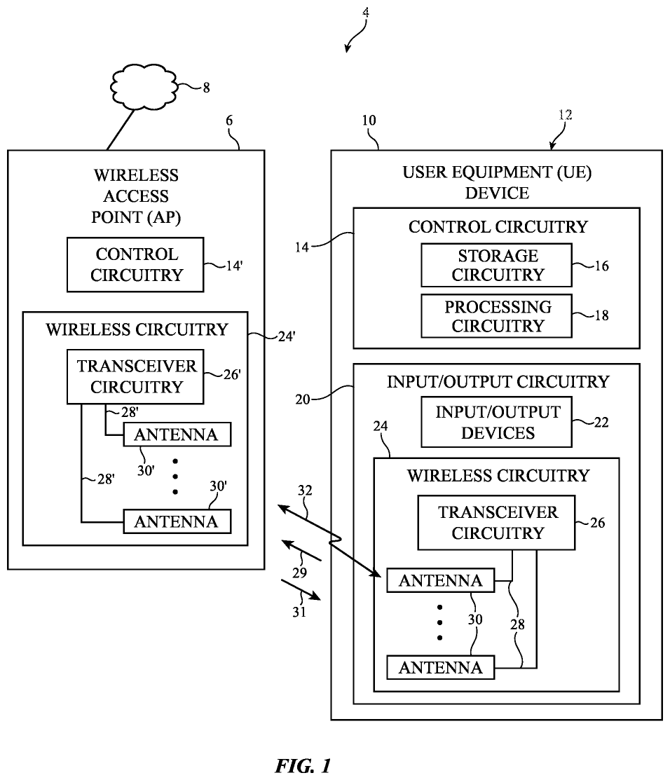

FIG. 1 is a schematic diagram of an illustrative communications system 4 (sometimes referred to herein as communications network 4) for conveying wireless data between communications terminals. Communications system 4 may include network nodes (e.g., communications terminals). The network nodes may include user equipment (UE) such as one or more UE devices 10. The network nodes may also include external communications equipment (e.g., communications equipment other than UE devices 10) such as external communications equipment 6. External communications equipment 6 may include one or more electronic devices and may be a wireless base station, wireless access point, or other wireless equipment for example. Implementations in which external communications equipment 6 is a wireless access point are described herein as an example. External communications equipment 6 may therefore sometimes be referred to herein as wireless access point 6 or simply as access point (AP) 6. UE devices 10 and AP 6 may communicate with each other using one or more wireless communications links If desired, UE devices 10 may wirelessly communicate with AP 6 without passing communications through any other intervening network nodes in communications system 4 (e.g., UE devices 10 may communicate directly with AP 6 over-the-air).

AP 6 may be communicably coupled to a larger communications network 8 via wired and/or wireless links. The larger communications network may include one or more wired communications links (e.g., communications links formed using cabling such as ethernet cables, radio-frequency cables such as coaxial cables or other transmission lines, optical fibers or other optical cables, etc.), one or more wireless communications links (e.g., short range wireless communications links that operate over a range of inches, feet, or tens of feet, medium range wireless communications links that operate over a range of hundreds of feet, thousands of feet, miles, or tens of miles, and/or long range wireless communications links that operate over a range of hundreds or thousands of miles, etc.), communications gateways, wireless access points, base stations, switches, routers, servers, modems, repeaters, telephone lines, network cards, line cards, portals, user equipment (e.g., computing devices, mobile devices, etc.), etc. The larger communications network may include communications (network) nodes or terminals coupled together using these components or other components (e.g., some or all of a mesh network, relay network, ring network, local area network, wireless local area network, personal area network, cloud network, star network, tree network, or networks of communications nodes having other network topologies), the Internet, combinations of these, etc. UE devices 10 may send data to and/or may receive data from other nodes or terminals in the larger communications network via AP 6 (e.g., AP 6 may serve as an interface between user equipment devices 10 and the rest of the larger communications network).

User equipment (UE) device 10 of FIG. 1 is an electronic device (sometimes referred to herein as electronic device 10, device 10, or electro-optical device 10) and may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses, goggles, or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, a wireless base station or access point, equipment that implements the functionality of two or more of these devices, or other electronic equipment.

As shown in the functional block diagram of FIG. 1, UE device 10 may include components located on or within an electronic device housing such as housing 12. Housing 12, which may sometimes be referred to as a case, may be formed of plastic, glass, ceramics, fiber composites, metal (e.g., stainless steel, aluminum, metal alloys, etc.), other suitable materials, or a combination of these materials. In some situations, part or all of housing 12 may be formed from dielectric or other low-conductivity material (e.g., glass, ceramic, plastic, sapphire, etc.). In other situations, housing 12 or at least some of the structures that make up housing 12 may be formed from metal elements.

UE device 10 may include control circuitry 14. Control circuitry 14 may include storage such as storage circuitry 16. Storage circuitry 16 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 16 may include storage that is integrated within device 10 and/or removable storage media.

Control circuitry 14 may include processing circuitry such as processing circuitry 18. Processing circuitry 18 may be used to control the operation of device 10. Processing circuitry 18 may include on one or more processors, microprocessors, microcontrollers, digital signal processors, host processors, baseband processor integrated circuits, application specific integrated circuits, central processing units (CPUs), graphics processing units (GPUs), etc. Control circuitry 14 may be configured to perform operations in device 10 using hardware (e.g., dedicated hardware or circuitry), firmware, and/or software. Software code for performing operations in device 10 may be stored on storage circuitry 16 (e.g., storage circuitry 16 may include non-transitory (tangible) computer readable storage media that stores the software code). The software code may sometimes be referred to as program instructions, software, data, instructions, or code. Software code stored on storage circuitry 16 may be executed by processing circuitry 18.

Control circuitry 14 may be used to run software on device 10 such as satellite navigation applications, internet browsing applications, voice-over-internet-protocol (VOIP) telephone call applications, email applications, media playback applications, operating system functions, etc. To support interactions with external equipment, control circuitry 14 may be used in implementing communications protocols. Communications protocols that may be implemented using control circuitry 14 include internet protocols, wireless local area network (WLAN) protocols (e.g., IEEE 802.11 protocols—sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, Sixth Generation (6G) protocols, sub-THz protocols, THz protocols, etc.), antenna diversity protocols, satellite navigation system protocols (e.g., global positioning system (GPS) protocols, global navigation satellite system (GLONASS) protocols, etc.), antenna-based spatial ranging protocols, optical communications protocols, or any other desired communications protocols. Each communications protocol may be associated with a corresponding radio access technology (RAT) that specifies the physical connection methodology used in implementing the protocol.

UE device 10 may include input-output circuitry 20. Input-output circuitry 20 may include input-output devices 22. Input-output devices 22 may be used to allow data to be supplied to UE device 10 and to allow data to be provided from UE device 10 to external devices. Input-output devices 22 may include user interface devices, data port devices, and other input-output components. For example, input-output devices 22 may include touch sensors, displays (e.g., touch-sensitive and/or force-sensitive displays), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), temperature sensors, etc. In some configurations, keyboards, headphones, displays, pointing devices such as trackpads, mice, and joysticks, and other input-output devices may be coupled to UE device 10 using wired or wireless connections (e.g., some of input-output devices 22 may be peripherals that are coupled to a main processing unit or other portion of UE device 10 via a wired or wireless link).

Input-output circuitry 20 may include wireless circuitry 24 to support wireless communications. Wireless circuitry 24 (sometimes referred to herein as wireless communications circuitry 24) may include one or more antennas 30.

Wireless circuitry 24 may also include transceiver circuitry 26. Transceiver circuitry 26 may include transmitter circuitry, receiver circuitry, modulator circuitry, demodulator circuitry (e.g., one or more modems), radio-frequency circuitry, one or more radios, intermediate frequency circuitry, optical transmitter circuitry, optical receiver circuitry, optical light sources, other optical components, baseband circuitry (e.g., one or more baseband processors), amplifier circuitry, clocking circuitry such as one or more local oscillators and/or phase-locked loops, memory, one or more registers, filter circuitry, switching circuitry, analog-to-digital converter (ADC) circuitry, digital-to-analog converter (DAC) circuitry, radio-frequency transmission lines, optical fibers, and/or any other circuitry for transmitting and/or receiving wireless signals using antennas 30. The components of transceiver circuitry 26 may be implemented on one integrated circuit, chip, system-on-chip (SOC), die, printed circuit board, substrate, or package, or the components of transceiver circuitry 26 may be distributed across two or more integrated circuits, chips, SOCs, printed circuit boards, substrates, and/or packages.

The example of FIG. 1 is merely illustrative. While control circuitry 14 is shown separately from wireless circuitry 24 in the example of FIG. 1 for the sake of clarity, wireless circuitry 24 may include processing circuitry (e.g., one or more processors) that forms a part of processing circuitry 18 and/or storage circuitry that forms a part of storage circuitry 16 of control circuitry 14 (e.g., portions of control circuitry 14 may be implemented on wireless circuitry 24). As an example, control circuitry 14 may include baseband circuitry (e.g., one or more baseband processors), digital control circuitry, analog control circuitry, and/or other control circuitry that forms part of wireless circuitry 24. The baseband circuitry may, for example, access a communication protocol stack on control circuitry 14 (e.g., storage circuitry 16) to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum layer.

Transceiver circuitry 26 may be coupled to each antenna 30 in wireless circuitry 24 over a respective signal path 28. Each signal path 28 may include one or more radio-frequency transmission lines, waveguides, optical fibers, and/or any other desired lines/paths for conveying wireless signals between transceiver circuitry 26 and antenna 30. Antennas 30 may be formed using any desired antenna structures for conveying wireless signals. For example, antennas 30 may include antennas with resonating elements that are formed from dipole antenna structures, planar dipole antenna structures (e.g., bowtie antenna structures), slot antenna structures, loop antenna structures, patch antenna structures, inverted-F antenna structures, planar inverted-F antenna structures, helical antenna structures, monopole antennas, dipoles, hybrids of these designs, etc. Filter circuitry, switching circuitry, impedance matching circuitry, and/or other antenna tuning components may be adjusted to adjust the frequency response and wireless performance of antennas 30 over time.

If desired, two or more of antennas 30 may be integrated into a phased antenna array (sometimes referred to herein as a phased array antenna or an array of antenna elements) in which each of the antennas conveys wireless signals with a respective phase and magnitude that is adjusted over time so the wireless signals constructively and destructively interfere to produce (form) a signal beam in a given pointing direction. The term “convey wireless signals” as used herein means the transmission and/or reception of the wireless signals (e.g., for performing unidirectional and/or bidirectional wireless communications with external wireless communications equipment). Antennas 30 may transmit the wireless signals by radiating the signals into free space (or to free space through intervening device structures such as a dielectric cover layer). Antennas 30 may additionally or alternatively receive the wireless signals from free space (e.g., through intervening devices structures such as a dielectric cover layer). The transmission and reception of wireless signals by antennas 30 each involve the excitation or resonance of antenna currents on an antenna resonating (radiating) element in the antenna by the wireless signals within the frequency band(s) of operation of the antenna.

Transceiver circuitry 26 may use antenna(s) 30 to transmit and/or receive wireless signals that convey wireless communications data between device 10 and external wireless communications equipment (e.g., one or more other devices such as device 10, a wireless access point or base station, etc.). The wireless communications data may be conveyed bidirectionally or unidirectionally. The wireless communications data may, for example, include data that has been encoded into corresponding data packets such as wireless data associated with a telephone call, streaming media content, internet browsing, wireless data associated with software applications running on device 10, email messages, etc.

Additionally or alternatively, wireless circuitry 24 may use antenna(s) 30 to perform wireless sensing operations. The sensing operations may allow device 10 to detect (e.g., sense or identify) the presence, location, orientation, and/or velocity (motion) of objects external to device 10. Control circuitry 14 may use the detected presence, location, orientation, and/or velocity of the external objects to perform any desired device operations. As examples, control circuitry 14 may use the detected presence, location, orientation, and/or velocity of the external objects to identify a corresponding user input for one or more software applications running on device 10 such as a gesture input performed by the user's hand(s) or other body parts or performed by an external stylus, gaming controller, head-mounted device, or other peripheral devices or accessories, to determine when one or more antennas 30 needs to be disabled or provided with a reduced maximum transmit power level (e.g., for satisfying regulatory limits on radio-frequency exposure), to determine how to steer (form) a radio-frequency signal beam produced by antennas 30 for wireless circuitry 24 (e.g., in scenarios where antennas 30 include a phased array of antennas 30), to map or model the environment around device 10 (e.g., to produce a software model of the room where device 10 is located for use by an augmented reality application, gaming application, map application, home design application, engineering application, etc.), to detect the presence of obstacles in the vicinity of (e.g., around) device 10 or in the direction of motion of the user of device 10, etc. The sensing operations may, for example, involve the transmission of sensing signals (e.g., radar waveforms), the receipt of corresponding reflected signals (e.g., the transmitted waveforms that have reflected off of external objects), and the processing of the transmitted signals and the received reflected signals (e.g., using a radar scheme).

Wireless circuitry 24 may transmit and/or receive wireless signals within corresponding frequency bands of the electromagnetic spectrum (sometimes referred to herein as communications bands or simply as “bands”). The frequency bands handled by wireless circuitry 24 may include wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, 6G bands, etc.), other centimeter or millimeter wave frequency bands between 10-100 GHz, near-field communications frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, and/or any other desired frequency bands of interest.

Over time, software applications on electronic devices such as device 10 have become more and more data intensive. Wireless circuitry on the electronic devices therefore needs to support data transfer at higher and higher data rates. In general, the data rates supported by the wireless circuitry are proportional to the frequency of the wireless signals conveyed by the wireless circuitry (e.g., higher frequencies can support higher data rates than lower frequencies). Wireless circuitry 24 may convey centimeter and millimeter wave signals to support relatively high data rates (e.g., because centimeter and millimeter wave signals are at relatively high frequencies between around 10 GHz and 100 GHz). However, the data rates supported by centimeter and millimeter wave signals may still be insufficient to meet all the data transfer needs of device 10. To support even higher data rates such as data rates up to 5-100 Gbps or higher, wireless circuitry 24 may convey wireless signals at frequencies greater than about 100 GHz.

As shown in FIG. 1, wireless circuitry 24 may transmit wireless signals 32 and/or may receive wireless signals 32 at frequencies greater than around 100 GHz (e.g., greater than 70 GHz, 80 GHz, 90 GHz, 110 GHz, etc.). Wireless signals 32 may sometimes be referred to herein as tremendously high frequency (THF) signals 32, sub-THz signals 32, THz signals 32, or sub-millimeter wave signals 32. THF signals 32 may be at sub-THz or THz frequencies such as frequencies between 100 GHz and 1 THz, between 80 GHz and 10 THz, between 100 GHz and 10 THz, between 100 GHz and 2 THz, between 200 GHz and 1 THz, between 300 GHz and 1 THz, between 300 GHz and 2 THz, between 70 GHz and 2 THz, between 300 GHz and 10 THz, between 100 GHz and 800 GHz, between 200 GHz and 1.5 THz, etc. (e.g., within a sub-THz, THz, THF, or sub-millimeter frequency band such as a 6G frequency band). The high data rates supported by these frequencies may be leveraged by device 10 to perform cellular telephone voice and/or data communications (e.g., while supporting spatial multiplexing to provide further data bandwidth), to perform spatial ranging operations such as radar operations to detect the presence, location, and/or velocity of objects external to device 10, to perform automotive sensing (e.g., with enhanced security), to perform health/body monitoring on a user of device 10 or another person, to perform gas or chemical detection, to form a high data rate wireless connection between device 10 and another device or peripheral device (e.g., to form a high data rate connection between a display driver on device 10 and a display that displays ultra-high resolution video), to form a remote radio head (e.g., a flexible high data rate connection), to form a THF chip-to-chip connection within device 10 that supports high data rates (e.g., where one antenna 30 on a first chip in device 10 transmits THF signals 32 to another antenna 30 on a second chip in device 10), and/or to perform any other desired high data rate operations.

Space is at a premium within electronic devices such as device 10. In some scenarios, different antennas 30 are used to transmit THF signals 32 than are used to receive THF signals 32. However, handling transmission of THF signals 32 and reception of THF signals 32 using different antennas 30 can consume an excessive amount of space and other resources within device 10 because two antennas 30 and signal paths 28 would be required to handle both transmission and reception. To minimize space and resource consumption within device 10, the same antenna 30 and signal path 28 may be used to both transmit THF signals 32 and to receive THF signals 32. If desired, multiple antennas 30 in wireless circuitry 24 may transmit THF signals 32 and may receive THF signals 32. The antennas may be integrated into a phased antenna array that transmits THF signals 32 and that receives THF signals 32 within a corresponding signal beam oriented in a selected beam pointing direction.

As shown in FIG. 1, AP 6 may also include control circuitry 14′ (e.g., control circuitry having similar components and/or functionality as control circuitry 14 in UE device 10) and wireless circuitry 24′ (e.g., wireless circuitry having similar components and/or functionality as wireless circuitry 24′ in UE device 10). Wireless circuitry 24′ may include transceiver circuitry 26′ (e.g., transceiver circuitry having similar components and/or functionality as transceiver circuitry 26 in UE device 10) coupled to two or more antennas 30′ (e.g., antennas having similar components and/or functionality as antennas 30 in UE device 10) over corresponding signal paths 28′ (e.g., signal paths having similar components and/or functionality as signal paths 28 in UE device 10). Antennas 30′ may be arranged in one or more phased antenna arrays. AP 6 may use wireless circuitry 24′ to transmit THF signals 32 to UE device 10 (e.g., as downlink (DL) signals transmitted in downlink direction 31) and/or to receive THF signals 32 transmitted by UE device 10 (e.g., as uplink (UL) signals transmitted in uplink direction 29).

It can be challenging to incorporate components into wireless circuitry 24 and 24′ that support wireless communications at these high frequencies. If desired, transceiver circuitry 26 and 26′ and signal paths 28 and 28′ may include optical components that convey optical signals to support the transmission and reception of THF signals 32 in a space and resource-efficient manner The optical signals may be used in transmitting THF signals 32 at THF frequencies and/or in receiving THF signals 32 at THF frequencies.

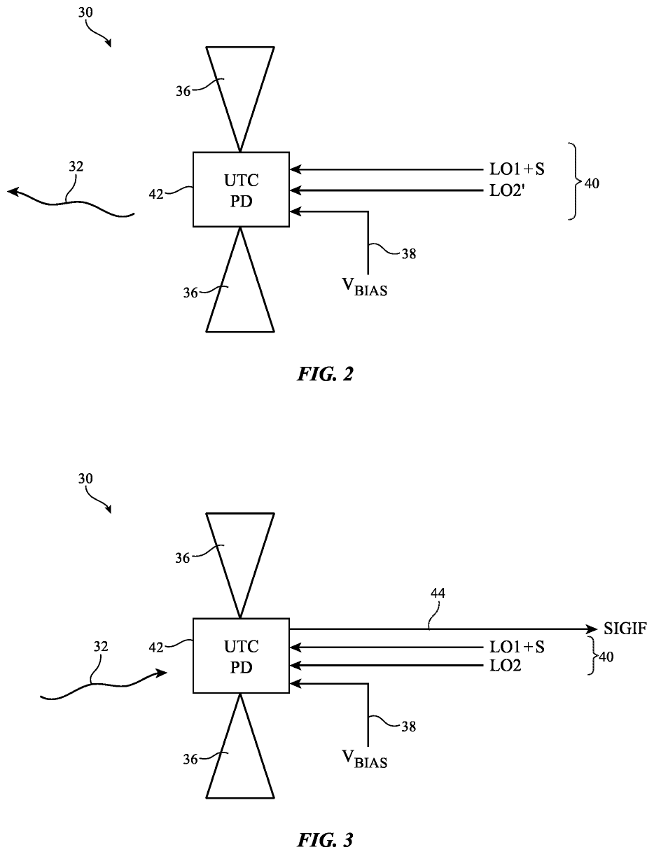

FIG. 2 is a diagram of an illustrative antenna 30 that may be used to both transmit THF signals 32 and to receive THF signals 32 in examples where AP 6 is an electro-optical device that conveys THF signals 32 using optical signals. This is merely illustrative. In particular, FIGS. 2-7 illustrate one exemplary implementation for how antenna 30 (or antenna 30′ in AP 6) may convey THF signals 32 using optical signals (e.g., in an example where UE device 10 and/or AP 6 are electro-optical devices). This is merely illustrative and, in general, UE device 10 and AP 6 may generate and convey THF signals using any desired array architecture(s) (e.g., where antenna 30 is fed using one or more transmission lines and one or more phase and magnitude controllers). AP 6 and UE device 10 need not be electro-optical devices. Antenna 30 may include one or more antenna radiating (resonating) elements 36 such as radiating (resonating) element arms. In the example of FIG. 2, antenna 30 is a planar dipole antenna (sometimes referred to as a “bowtie” antenna) having an antenna resonating element 36 with two opposing resonating element arms (e.g., bowtie arms or dipole arms). This is merely illustrative and, in general, antenna 30 may be any type of antenna having any desired antenna radiating element architecture.

As shown in FIG. 2 (e.g., in implementations where UE device 10 or AP 6 is an electro-optical device), antenna 30 includes a photodiode (PD) 42 coupled between the arms of antenna resonating element 36. Electronic devices that include antennas 30 with photodiodes 42 such as device 10 may sometimes also be referred to as electro-optical devices. Photodiode 42 may be a programmable photodiode. An example in which photodiode 42 is a programmable uni-travelling-carrier photodiode (UTC PD) is described herein as an example. Photodiode 42 may therefore sometimes be referred to herein as UTC PD 42 or programmable UTC PD 42. This is merely illustrative and, in general, photodiode 42 may include any desired type of adjustable/programmable photodiode or component that converts electromagnetic energy at optical frequencies to current at THF frequencies on antenna resonating element 36 and/or vice versa (e.g., a p-i-n diode, a tunneling diode, a TW UTC photodiode, other diodes with quadratic characteristics, an LT-GaAS photodiode, an M-UTC photodiode, etc.). Each radiating element arm in antenna resonating element 36 may, for example, have a first edge at UTC PD 42 and a second edge opposite the first edge that is wider than the first edge (e.g., in implementations where antenna 30 is a bowtie antenna). Other radiating elements may be used if desired.

UTC PD 42 may have a bias terminal (input) 38 that receives one or more control signals V_{BIAS}. Control signals V_{BIAS} may include bias voltages provided at one or more voltage levels and/or other control signals for controlling the operation of UTC PD 42 such as impedance adjustment control signals for adjusting the output impedance of UTC PD 42. Control circuitry 14 (FIG. 1) may provide (e.g., apply, supply, assert, etc.) control signals V_{BIAS} at different settings (e.g., values, magnitudes, etc.) to dynamically control (e.g., program or adjust) the operation of UTC PD 42 over time. For example, control signals V_{BIAS} may be used to control whether antenna 30 transmits THF signals 32 or receives THF signals 32. When control signals V_{BIAS} include a bias voltage asserted at a first level or magnitude, antenna 30 may be configured to transmit THF signals 32. When control signals V_{BIAS} include a bias voltage asserted at a second level or magnitude, antenna 30 may be configured to receive THF signals 32. In the example of FIG. 2, control signals V_{BIAS} include the bias voltage asserted at the first level to configure antenna 30 to transmit THF signals 32. If desired, control signals V_{BIAS} may also be adjusted to control the waveform of the THF signals (e.g., as a squaring function that preserves the modulation of incident optical signals, a linear function, etc.), to perform gain control on the signals conveyed by antenna 30, and/or to adjust the output impedance of UTC PD 42.

As shown in FIG. 2 (e.g., in implementations where UE device 10 or AP 6 is an electro-optical device), UTC PD 42 may be optically coupled to optical path 40. Optical path 40 may include one or more optical fibers or waveguides. UTC PD 42 may receive optical signals from transceiver circuitry 26 (FIG. 1) over optical path 40. The optical signals may include a first optical local oscillator (LO) signal LO1 and a second optical local oscillator signal LO2. Optical local oscillator signals LO1 and LO2 may be generated by light sources in transceiver circuitry 26 (FIG. 1). Optical local oscillator signals LO1 and LO2 may be at optical wavelengths (e.g., between 400 nm and 700 nm), ultra-violet wavelengths (e.g., near-ultra-violet or extreme ultraviolet wavelengths), and/or infrared wavelengths (e.g., near-infrared wavelengths, mid-infrared wavelengths, or far-infrared wavelengths). Optical local oscillator signal LO2 may be offset in wavelength from optical local oscillator signal LO1 by a wavelength offset X. Wavelength offset X may be equal to the wavelength of the THF signals conveyed by antenna 30 (e.g., between 100 GHz and 1 THz (1000 GHz), between 100 GHz and 2 THz, between 300 GHz and 800 GHz, between 300 GHz and 1 THz, between 300 and 400 GHz, etc.).

During signal transmission, wireless data (e.g., wireless data packets, symbols, frames, etc.) may be modulated onto optical local oscillator signal LO2 to produce modulated optical local oscillator signal LO2′. If desired, optical local oscillator signal LO1 may be provided with an optical phase shift S. Optical path 40 may illuminate UTC PD 42 with optical local oscillator signal LO1 (plus the optical phase shift S when applied) and modulated optical local oscillator signal LO2′. If desired, lenses or other optical components may be interposed between optical path 40 and UTC PD 42 to help focus the optical local oscillator signals onto UTC PD 42.

UTC PD 42 may convert optical local oscillator signal LO1 and modulated local oscillator signal LO2′ (e.g., beats between the two optical local oscillator signals) into antenna currents that run along the perimeter of the radiating element arms in antenna resonating element 36. The frequency of the antenna current is equal to the frequency difference between local oscillator signal LO1 and modulated local oscillator signal LO2′. The antenna currents may radiate (transmit) THF signals 32 into free space. Control signal V_{BIAS} may control UTC PD 42 to convert the optical local oscillator signals into antenna currents on the radiating element arms in antenna resonating element 36 while preserving the modulation and thus the wireless data on modulated local oscillator signal LO2′ (e.g., by applying a squaring function to the signals). THF signals 32 will thereby carry the modulated wireless data for reception and demodulation by external wireless communications equipment.

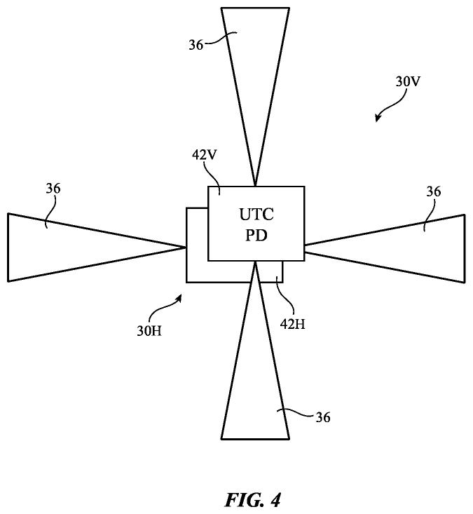

FIG. 3 is a diagram showing how antenna 30 may receive THF signals 32 (e.g., after changing the setting of control signals V_{BIAS} into a reception state from the transmission state of FIG. 2, in implementations where UE device 10 or AP 6 is an electro-optical device). As shown in FIG. 3, THF signals 32 may be incident upon the antenna radiating element arms of antenna resonating element 36. The incident THF signals 32 may produce antenna currents that flow around the perimeter of the radiating element arms in antenna resonating element 36. UTC PD 42 may use optical local oscillator signal LO1 (plus the optical phase shift S when applied), optical local oscillator signal LO2 (e.g., without modulation), and control signals V_{BIAS} (e.g., a bias voltage asserted at the second level) to convert the received THF signals 32 into intermediate frequency signals SIGIF that are output onto intermediate frequency signal path 44.

The frequency of intermediate frequency signals SIGIF may be equal to the frequency of THF signals 32 minus the difference between the frequency of optical local oscillator signal LO1 and the frequency of optical local oscillator signal LO2. As an example, intermediate frequency signals SIGIF may be at lower frequencies than THF signals such as centimeter or millimeter wave frequencies between 10 GHz and 100 GHz, between 30 GHz and 80 GHz, around 60 GHz, etc. If desired, transceiver circuitry 26 (FIG. 1) may change the frequency of optical local oscillator signal LO1 and/or optical local oscillator signal LO2 when switching from transmission to reception or vice versa. UTC PD 42 may preserve the data modulation of THF signals 32 in intermediate signals SIGIF. A receiver in transceiver circuitry 26 (FIG. 1) may demodulate intermediate frequency signals SIGIF (e.g., after further downconversion) to recover the wireless data from THF signals 32. In another example, wireless circuitry 24 may convert intermediate frequency signals SIGIF to the optical domain before recovering the wireless data. In yet another example, intermediate frequency signal path 44 may be omitted and UTC PD 42 may convert THF signals 32 into the optical domain for subsequent demodulation and data recovery (e.g., in a sideband of the optical signal).

While FIGS. 2 and 3 show an illustrative antenna 30 from UE device 10, similar structures may additionally or alternatively be used to form antenna 30′ on AP 6 (e.g., where antenna 30′ conveys signals for transceiver circuitry 26′ in wireless circuitry 24′ of FIG. 1 instead of for transceiver circuitry 26 in wireless circuitry 24 as described in connection with FIGS. 2 and 3). The antenna 30 of FIGS. 2 and 3 may support transmission of THF signals 32 and reception of THF signals 32 with a given polarization (e.g., a linear polarization such as a vertical polarization). If desired, wireless circuitry 24 and/or 24′ (FIG. 1) may include multiple antennas 30 and/or 30′ for covering different polarizations. FIG. 4 is a diagram showing one example of how wireless circuitry 24 in UE device 10 may include multiple antennas 30 for covering different polarizations. While FIG. 4 shows illustrative antennas 30 from UE device 10, similar structures may additionally or alternatively be used to form antenna 30′ on AP 6.

As shown in FIG. 4, the wireless circuitry may include a first antenna 30 such as antenna 30V for covering a first polarization (e.g., a first linear polarization such as a vertical polarization) and may include a second antenna 30 such as antenna 30H for covering a second polarization different from or orthogonal to the first polarization (e.g., a second linear polarization such as a horizontal polarization). Antenna 30V may have a UTC PD 42 such as UTC PD 42V coupled between a corresponding pair of radiating element arms in antenna resonating element 36. Antenna 30H may have a UTC PD 42 such as UTC PD 42H coupled between a corresponding pair of radiating element arms in antenna resonating element 36 oriented non-parallel (e.g., orthogonal) to the radiating element arms in antenna resonating element 36 of antenna 30V. This may allow antennas 30V and 30H to transmit THF signals 32 with respective (orthogonal) polarizations and may allow antennas 30V and 30H to receive THF signals 32 with respective (orthogonal) polarizations.

To minimize space within device 10, antenna 30V may be vertically stacked over or under antenna 30H (e.g., where UTC PD 42V partially or completely overlaps UTC PD 42H). In this example, antennas 30V and 30H may both be formed on the same substrate such as a rigid or flexible printed circuit board. The substrate may include multiple stacked dielectric layers (e.g., layers of ceramic, epoxy, flexible printed circuit board material, rigid printed circuit board material, etc.). The antenna resonating element 36 in antenna 30V may be formed on a separate layer of the substrate than the antenna resonating element 36 in antenna 30H or the antenna resonating element 36 in antenna 30V may be formed on the same layer of the substrate as the antenna resonating element 36 in antenna 30H. UTC PD 42V may be formed on the same layer of the substrate as UTC PD 42H or UTC PD 42V may be formed on a separate layer of the substrate than UTC PD 42H. UTC PD 42V may be formed on the same layer of the substrate as the antenna resonating element 36 in antenna 30V or may be formed on a separate layer of the substrate as the antenna resonating element 36 in antenna 30V. UTC PD 42H may be formed on the same layer of the substrate as the antenna resonating element 36 in antenna 30H or may be formed on a separate layer of the substrate as the antenna resonating element 36 in antenna 30H.

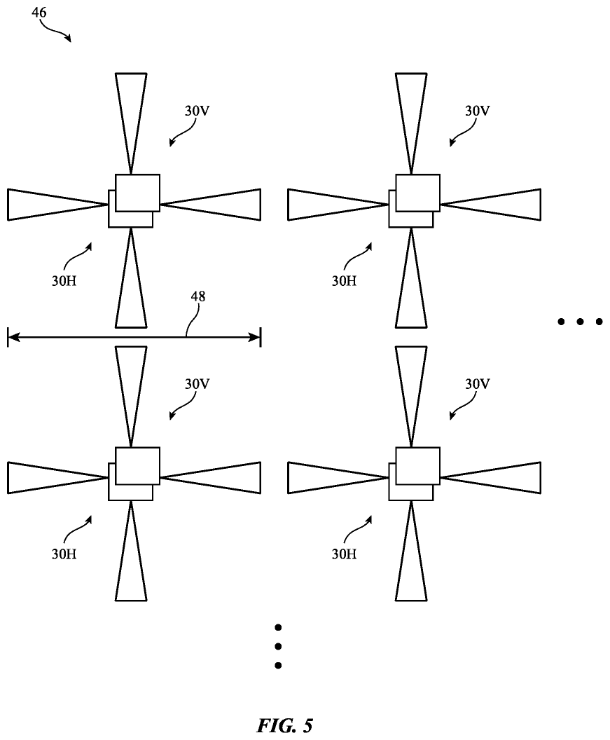

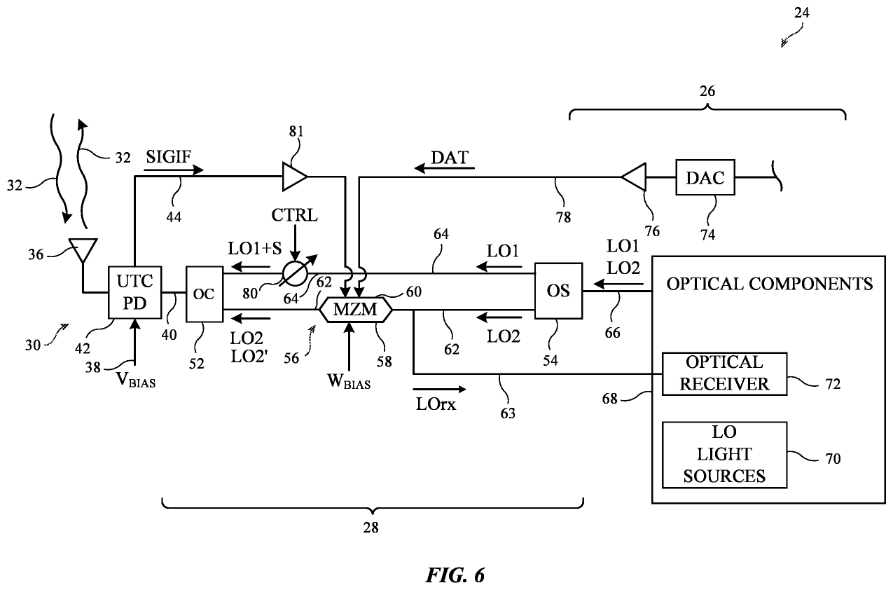

If desired, antennas 30 or antennas 30H and 30V of FIG. 4 may be integrated within a phased antenna array. FIG. 5 is a diagram showing one example of how antennas 30H and 30V may be integrated within a phased antenna array. As shown in FIG. 5, UE device 10 may include a phased antenna array 46 of stacked antennas 30H and 30V arranged in a rectangular grid of rows and columns. Each of the antennas in phased antenna array 46 may be formed on the same substrate. This is merely illustrative. In general, phased antenna array 46 may include any desired number of antennas 30V and 30H (or non-stacked antennas 30) arranged in any desired pattern. Each of the antennas in phased antenna array 46 may be provided with a respective optical phase shift S (FIGS. 2 and 3) that configures the antennas to collectively transmit THF signals 32 and/or receive THF signals 32 that sum to form a signal beam of THF signals in a desired beam pointing direction. The beam pointing direction may be selected to point the signal beam towards external communications equipment, towards a desired external object, away from an external object, etc. Phased antenna array 46 may also sometimes be referred to herein as an array of antenna elements (e.g., where each antenna 30V and each antenna 30H or the antenna radiating elements thereof forms a respective antenna element in the array of antenna elements).

Phased antenna array 46 may occupy relatively little space within device 10. For example, each antenna 30V/30H may have a length 48 (e.g., as measured from the end of one radiating element arm to the opposing end of the opposite radiating element arm). Length 48 may be approximately equal to one-half the wavelength of THF signals 32. For example, length 48 may be as small as 0.5 mm or less. Each UTC-PD 42 in phased antenna array 46 may occupy a lateral area of 100 square microns or less. This may allow phased antenna array 46 to occupy very little area within UE device 10, thereby allowing the phased antenna array to be integrated within different portions of device 10 while still allowing other space for device components. While FIG. 5 shows an illustrative phased antenna array that may be formed in UE device 10, similar structures may additionally or alternatively be used to form a phased antenna array on AP 6 (e.g., using antennas 30′ of FIG. 1). The examples of FIGS. 2-5 are merely illustrative and, in general, each antenna may have any desired antenna radiating element architecture.

FIG. 6 is a circuit diagram showing how a given antenna 30, signal path 28, and transceiver circuitry 26 may be used to both transmit THF signals 32 and receive THF signals 32 based on optical local oscillator signals. While FIG. 6 illustrates an antenna 30, signal path 28, and transceiver circuitry 26 from UE device 10, similar structures may additionally or alternatively be used to form antenna 30′, signal path 28′, and transceiver circuitry 26, respectively, on AP 6 (FIG. 1). In the example of FIG. 6, UTC PD 42 converts received THF signals 32 into intermediate frequency signals SIGIF that are then converted to the optical domain for recovering the wireless data from the received THF signals.

As shown in FIG. 6, wireless circuitry 24 may include transceiver circuitry 26 coupled to antenna 30 over signal path 28 (e.g., an optical signal path sometimes referred to herein as optical signal path 28). UTC PD 42 may be coupled between the radiating element arm(s) in antenna resonating element 36 of antenna 30 and signal path 28. Transceiver circuitry 26 may include optical components 68, amplifier circuitry such as power amplifier 76, and digital-to-analog converter (DAC) 74. Optical components 68 may include an optical receiver such as optical receiver 72 and optical local oscillator (LO) light sources (emitters) 70. LO light sources 70 may include two or more light sources such as laser light sources, laser diodes, optical phase locked loops, or other optical emitters that emit light (e.g., optical local oscillator signals LO1 and LO2) at respective wavelengths. If desired, LO light sources 70 may include a single light source and may include optical components for splitting the light emitted by the light source into different wavelengths. Signal path 28 may be coupled to optical components 68 over optical path 66. Optical path 66 may include one or more optical fibers and/or waveguides.

Signal path 28 may include an optical splitter such as optical splitter (OS) 54, optical paths such as optical path 64 and optical path 62, an optical combiner such as optical combiner (OC) 52, and optical path 40. Optical path 62 may be an optical fiber or waveguide. Optical path 64 may be an optical fiber or waveguide. Optical splitter 54 may have a first (e.g., input) port coupled to optical path 66, a second (e.g., output) port coupled to optical path 62, and a third (e.g., output) port coupled to optical path 64. Optical path 64 may couple optical splitter 54 to a first (e.g., input) port of optical combiner 52. Optical path 62 may couple optical splitter 54 to a second (e.g., input) port of optical combiner 52. Optical combiner 52 may have a third (e.g., output) port coupled to optical path 40.

An optical phase shifter such as optical phase shifter 80 may be (optically) interposed on or along optical path 64. An optical modulator such as optical modulator 56 may be (optically) interposed on or along optical path 62. Optical modulator 56 may be, for example, a Mach-Zehnder modulator (MZM) and may therefore sometimes be referred to herein as MZM 56. MZM 56 includes a first optical arm (branch) 60 and a second optical arm (branch) 58 interposed in parallel along optical path 62. Propagating optical local oscillator signal LO2 along arms 60 and 58 of MZM 56 may, in the presence of a voltage signal applied to one or both arms, allow different optical phase shifts to be imparted on each arm before recombining the signal at the output of the MZM (e.g., where optical phase modulations produced on the arms are converted to intensity modulations at the output of MZM 56). When the voltage applied to MZM 56 includes wireless data, MZM 56 may modulate the wireless data onto optical local oscillator signal LO2. If desired, the phase shifting performed at MZM 56 may be used to perform beam forming/steering in addition to or instead of optical phase shifter 80. MZM 56 may receive one or more bias voltages W_{BIAS} (sometimes referred to herein as bias signals W_{BIAS}) applied to one or both of arms 58 and 60. Control circuitry 14 (FIG. 1) may provide bias voltage W_{BIAS} with different magnitudes to place MZM 56 into different operating modes (e.g., operating modes that suppress optical carrier signals, operating modes that do not suppress optical carrier signals, etc.).

Intermediate frequency signal path 44 may couple UTC PD 42 to MZM 56 (e.g., arm 60). An amplifier such as low noise amplifier 81 may be interposed on intermediate frequency signal path 44. Intermediate frequency signal path 44 may be used to pass intermediate frequency signals SIGIF from UTC PD 42 to MZM 56. DAC 74 may have an input coupled to up-conversion circuitry, modulator circuitry, and/or baseband circuitry in a transmitter of transceiver circuitry 26. DAC 74 may receive digital data to transmit over antenna 30 and may convert the digital data to the analog domain (e.g., as data DAT). DAC 74 may have an output coupled to transmit data path 78. Transmit data path 78 may couple DAC 74 to MZM 56 (e.g., arm 60). Each of the components along signal path 28 may allow the same antenna 30 to both transmit THF signals 32 and receive THF signals 32 (e.g., using the same components along signal path 28), thereby minimizing space and resource consumption within device 10.

LO light sources 70 may produce (emit) optical local oscillator signals LO1 and LO2 (e.g., at different wavelengths that are separated by the wavelength of THF signals 32). Optical components 68 may include lenses, waveguides, optical couplers, optical fibers, and/or other optical components that direct the emitted optical local oscillator signals LO1 and LO2 towards optical splitter 54 via optical path 66. Optical splitter 54 may split the optical signals on optical path 66 (e.g., by wavelength) to output optical local oscillator signal LO1 onto optical path 64 while outputting optical local oscillator signal LO2 onto optical path 62.

Control circuitry may provide phase control signals CTRL to optical phase shifter 80. Phase control signals CTRL may control optical phase shifter 80 to apply optical phase shift S to the optical local oscillator signal LO1 on optical path 64. Phase shift S may be selected to steer a signal beam of THF signals 32 in a desired pointing direction. Optical phase shifter 80 may pass the phase-shifted optical local oscillator signal LO1 (denoted as LO1+S) to optical combiner 52. Signal beam steering is performed in the optical domain (e.g., using optical phase shifter 80) rather than in the THF domain because there are no satisfactory phase shifting circuit components that operate at frequencies as high as the frequencies of THF signals 32. Optical combiner 52 may receive optical local oscillator signal LO2 over optical path 62. Optical combiner 52 may combine optical local oscillator signals LO1 and LO2 onto optical path 40, which directs the optical local oscillator signals onto UTC PD 42 for use during signal transmission or reception.

During transmission of THF signals 32, DAC 74 may receive digital wireless data (e.g., data packets, frames, symbols, etc.) for transmission over THF signals 32. DAC 74 may convert the digital wireless data to the analog domain and may output (transmit) the data onto transmit data path 78 as data DAT (e.g., for transmission via antenna 30). Power amplifier 76 may amplify data DAT. Transmit data path 78 may pass data DAT to MZM 56 (e.g., arm 60). MZM 56 may modulate data DAT onto optical local oscillator signal LO2 to produce modulated optical local oscillator signal LO2′ (e.g., an optical local oscillator signal at the frequency/wavelength of optical local oscillator signal LO2 but that is modulated to include the data identified by data DAT). Optical combiner 52 may combine optical local oscillator signal LO1 with modulated optical local oscillator signal LO2′ at optical path 40.

Optical path 40 may illuminate UTC PD 42 with (using) optical local oscillator signal LO1 (e.g., with the phase shift S applied by optical phase shifter 80) and modulated optical local oscillator signal LO2′. Control circuitry may apply a control signal V_{BIAS} to UTC PD 42 that configures antenna 30 for the transmission of THF signals 32. UTC PD 42 may convert optical local oscillator signal LO1 and modulated optical local oscillator signal LO2′ into antenna currents on antenna resonating element 36 at the frequency of THF signals 32 (e.g., while programmed for transmission using control signal V_{BIAS}). The antenna currents on antenna resonating element 36 may radiate THF signals 32. The frequency of THF signals 32 is given by the difference in frequency between optical local oscillator signal LO1 and modulated optical local oscillator signal LO2′. Control signals V_{BIAS} may control UTC PD 42 to preserve the modulation from modulated optical local oscillator signal LO2′ in the radiated THF signals 32. External equipment that receives THF signals 32 will thereby be able to extract data DAT from the THF signals 32 transmitted by antenna 30.

During reception of THF signals 32, MZM 56 does not modulate any data onto optical local oscillator signal LO2. Optical path 40 therefore illuminates UTC PD 42 with optical local oscillator signal LO1 (e.g., with phase shift S) and optical local oscillator signal LO2. Control circuitry may apply a control signal V_{BIAS} (e.g., a bias voltage) to UTC PD 42 that configures antenna 30 for the receipt of THF signals 32. UTC PD 42 may use optical local oscillator signals LO1 and LO2 to convert the received THF signals 32 into intermediate frequency signals SIGIF output onto intermediate frequency signal path 44 (e.g., while programmed for reception using bias voltage V_{BIAS}). Intermediate frequency signals SIGIF may include the modulated data from the received THF signals 32. Low noise amplifier 81 may amplify intermediate frequency signals SIGIF, which are then provided to MZM 56 (e.g., arm 60). MZM 56 may convert intermediate frequency signals SIGIF to the optical domain as optical signals LOrx (e.g., by modulating the data in intermediate frequency signals SIGIF onto one of the optical local oscillator signals) and may pass the optical signals to optical receiver 72 in optical components 68, as shown by arrow 63 (e.g., via optical paths 62 and 66 or other optical paths). Control circuitry may use optical receiver 72 to convert optical signals LOrx to other formats and to recover (demodulate) the data carried by THF signals 32 from the optical signals. In this way, the same antenna 30 and signal path 28 may be used for both the transmission and reception of THF signals while also performing beam steering operations.

The example of FIG. 6 in which intermediate frequency signals SIGIF are converted to the optical domain is merely illustrative. If desired, transceiver circuitry 26 may receive and demodulate intermediate frequency signals SIGIF without first passing the signals to the optical domain For example, transceiver circuitry 26 may include an analog-to-digital converter (ADC), intermediate frequency signal path 44 may be coupled to an input of the ADC rather than to MZM 56, and the ADC may convert intermediate frequency signals SIGIF to the digital domain. As another example, intermediate frequency signal path 44 may be omitted and control signals V_{BIAS} may control UTC PD 42 to directly sample THF signals 32 with optical local oscillator signals LO1 and LO2 to the optical domain. As an example, UTC PD 42 may use the received THF signals 32 and control signals V_{BIAS} to produce an optical signal on optical path 40. The optical signal may have an optical carrier with sidebands that are separated from the optical carrier by a fixed frequency offset (e.g., 30-100 GHz, 60 GHz, 50-70 GHz, 10-100 GHz, etc.). The sidebands may be used to carry the modulated data from the received THF signals 32. Signal path 28 may direct (propagate) the optical signal produced by UTC PD 42 to optical receiver 72 in optical components 68 (e.g., via optical paths 40, 64, 62, 66, 63, and/or other optical paths). Control circuitry may use optical receiver 72 to convert the optical signal to other formats and to recover (demodulate) the data carried by THF signals 32 from the optical signal (e.g., from the sidebands of the optical signal).

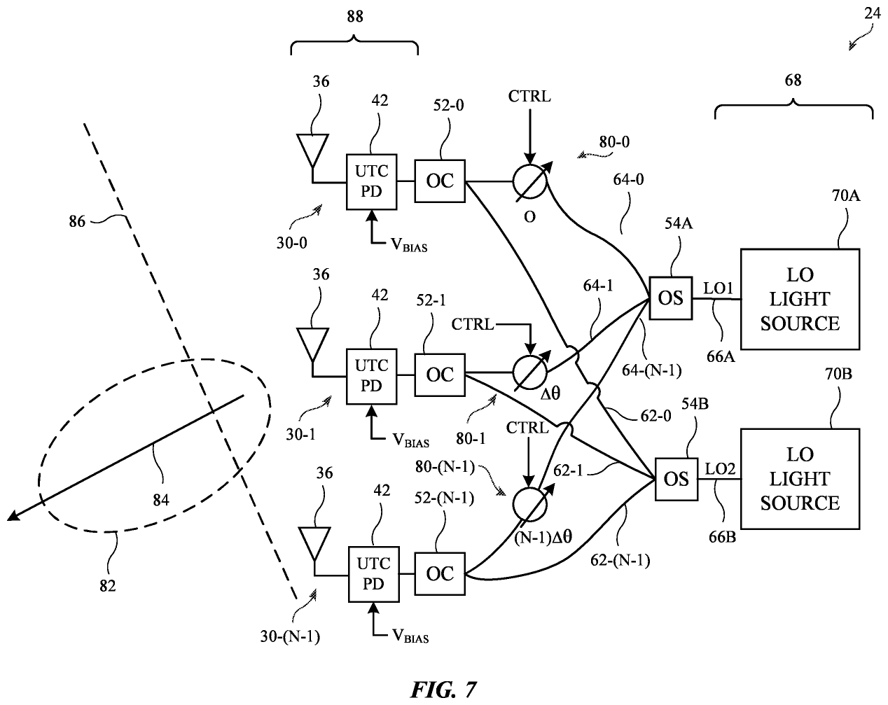

FIG. 7 is a circuit diagram showing one example of how multiple antennas 30 may be integrated into a phased antenna array 88 that conveys THF signals over a corresponding signal beam (e.g., in examples where UE device 10 and/or AP 6 are electro-optical or photonic devices). The example of FIG. 7 is merely illustrative and, in general, phased antenna array 88 may be implemented using any desired array architecture (e.g., phased antenna array 88 need not use optical signals for conveying THF signals 32 and, in general, may include a set of antennas 30/30′ coupled to any respective phase and/or magnitude controllers that are used for performing the beamforming operations as described herein). In the example of FIG. 7, MZMs 56, intermediate frequency signal paths 44, data paths 78, and optical receiver 72 of FIG. 6 have been omitted for the sake of clarity. Each of the antennas in phased antenna array 88 may alternatively sample received THF signals directly into the optical domain or may pass intermediate frequency signals SIGIF to ADCs in transceiver circuitry 26.

As shown in FIG. 7, phased antenna array 88 includes N antennas 30 such as a first antenna 30-0, a second antenna 30-1, an Nth antenna 30-(N-1), etc. Each of the antennas 30 in phased antenna array 88 may be coupled to optical components 68 via a respective optical signal path (e.g., optical signal path 28 of FIG. 6). Each of the N signal paths may include a respective optical combiner 52 coupled to the UTC PD 42 of the corresponding antenna 30 (e.g., the UTC PD 42 in antenna 30-0 may be coupled to optical combiner 52-0, the UTC PD 42 in antenna 30-1 may be coupled to optical combiner 52-1, the UTC PD 42 in antenna 30-(N-1) may be coupled to optical combiner 52-(N-1), etc.). Each of the N signal paths may also include a respective optical path 62 and a respective optical path 64 coupled to the corresponding optical combiner 52 (e.g., optical paths 64-0 and 62-0 may be coupled to optical combiner 52-0, optical paths 64-1 and 62-1 may be coupled to optical combiner 52-1, optical paths 64-(N-1) and 62-(N-1) may be coupled to optical combiner 52-(N-1), etc.).

Optical components 68 may include LO light sources 70 such as a first LO light source 70A and a second LO light source 70B. The optical signal paths for each of the antennas 30 in phased antenna array 88 may share one or more optical splitters 54 such as a first optical splitter 54A and a second optical splitter 54B. LO light source 70A may generate (e.g., produce, emit, transmit, etc.) first optical local oscillator signal LO1 and may provide first optical local oscillator signal LO1 to optical splitter 54A via optical path 66A. Optical splitter 54A may distribute first optical local oscillator signal LO1 to each of the UTC PDs 42 in phased antenna array 88 over optical paths 64 (e.g., optical paths 64-0, 64-1, 64-(N-1), etc.). Similarly, LO light source 70B may generate (e.g., produce, emit, transmit, etc.) second optical local oscillator signal LO2 and may provide second optical local oscillator signal LO2 to optical splitter 54B via optical path 66B. Optical splitter 54B may distribute second optical local oscillator signal LO2 to each of the UTC PDs 42 in phased antenna array 88 over optical paths 62 (e.g., optical paths 62-0, 62-1, 62-(N-1), etc.).

A respective optical phase shifter 80 may be interposed along (on) each optical path 64 (e.g., a first optical phase shifter 80-0 may be interposed along optical path 64-0, a second optical phase shifter 80-1 may be interposed along optical path 64-1, an Nth optical phase shifter 80-(N-1) may be interposed along optical path 64-(N-1), etc.). Each optical phase shifter 80 may receive a control signal CTRL that controls the phase S provided to optical local oscillator signal LO1 by that optical phase shifter (e.g., first optical phase shifter 80-0 may impart an optical phase shift of zero degrees/radians to the optical local oscillator signal LO1 provided to antenna 30-0, second optical phase shifter 80-1 may impart an optical phase shift of Δϕ to the optical local oscillator signal LO1 provided to antenna 30-1, Nth optical phase shifter 80-(N-1) may impart an optical phase shift of (N-1)Δϕ to the optical local oscillator signal LO1 provided to antenna 30-(N-1), etc.). By adjusting the phase S imparted by each of the N optical phase shifters 80, control circuitry 14 (FIG. 1) may control each of the antennas 30 in phased antenna array 88 to transmit THF signals 32 and/or to receive THF signals 32 within a formed signal beam 82. Signal beam 82 may be oriented in a particular beam pointing direction (angle) 84 (e.g., the direction of peak gain of signal beam 82). The THF signals conveyed by phased antenna array 88 may have wavefronts 86 that are orthogonal to beam pointing direction 84. Control circuitry 14 may adjust beam pointing direction 84 over time to point towards external communications equipment or an external object or to point away from external objects, as examples. While FIG. 7 shows an illustrative phased antenna array 88 of antennas 30 from UE device 10, similar structures may additionally or alternatively be used to form a phased antenna array of antennas 30′ in AP 6 (sometimes referred to herein as phased antenna array 88′).

While communications at frequencies greater than about 100 GHz allow for extremely high data rates (e.g., greater than 100 Gbps), radio-frequency signals at such high frequencies are subject to significant attenuation during propagation over-the-air. Integrating antennas 30 and 30′ into phased antenna arrays helps to counteract this attenuation by boosting the gain of the signals in producing signal beam 82. However, signal beam 82 is highly directive and may require a line-of-sight (LOS) between UE device 10 and AP 6. If an external object is present between AP 6 and UE device 10, the external object may block the LOS between UE device 10 and access point 6, which can disrupt wireless communications using THF signals 32. If desired, a reconfigurable intelligent surface (RIS) may be used to allow UE device 10 and AP 6 to continue to communicate using THF signals 32 even when an external object blocks the LOS between UE device 10 and AP 6.

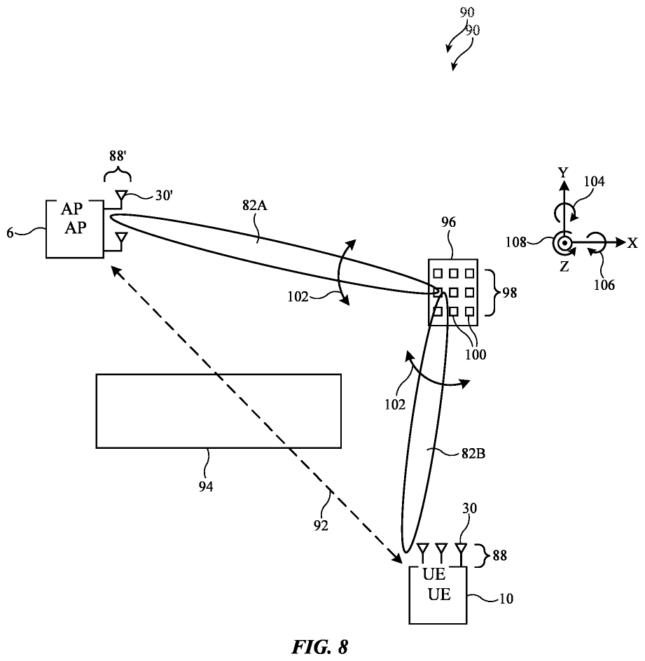

FIG. 8 is a diagram of an exemplary environment 90 in which a reconfigurable intelligent surface (RIS) is used to allow UE device 10 and AP 6 to continue to communicate using THF signals 32 despite the presence of an external object in the LOS between UE device 10 and AP 6. As shown in FIG. 8, AP 6 may be at a first location in environment 90 and UE device 10 may be at a second location in environment 90. AP 6 may be separated from UE device 10 by LOS path 92. In some circumstances, an external object such as object 94 may block LOS path 92. Object 94 may be, for example, furniture, a body or body part, an animal, a wall or corner of a room, a cubicle wall, a vehicle, a landscape feature, or other obstacles or objects that may block LOS path 92.

In the absence of external object 94, AP 6 may form a corresponding signal beam (e.g., signal beam 82 of FIG. 7) oriented in the direction of UE device 10 and UE device 10 may form a corresponding signal beam (e.g., signal beam 82 of FIG. 7) oriented in the direction of AP 6. AP 6 may form a corresponding AP beam oriented towards UE device 10 (e.g., over LOS path 92) and UE device 10 may form a corresponding UE beam oriented towards UE device 10 (e.g., over LOS path 92 and overlapping the AP beam). UE device 10 and AP 6 can then convey THF signals 32 over their respective beams and LOS path 92.

However, the presence of external object 94 prevents THF signals 32 from being conveyed over LOS path 92. RIS 96 may be placed or disposed within environment 90 to allow UE device 10 and AP 6 to exchange THF signals 32 despite the presence of external object 94 within LOS path 92. RIS 96 may also be used to reflect signals between UE device 10 and AP 6 when reflection via RIS 96 offers superior radio-frequency propagation conditions to LOS path 92 (e.g., when the LOS between AP 6 and RIS 96 and the LOS between RIS 96 and UE device 10 collectively exhibit better radio-frequency channel conditions than LOS path 92).

RIS 96 (sometimes referred to as intelligent reflective/reconfigurable surface (IRS) 96, reflective surface 96, reconfigurable surface 96, or electronic device 96) is an electronic device that includes a two-dimensional surface of engineered material having reconfigurable properties for performing communications between AP 6 and UE device 10. RIS 96 may include an array 98 of antenna elements 100 on an underlying substrate. The substrate may be a rigid or flexible printed circuit board, a package, a plastic substrate, meta-material, or any other desired substrate. The substrate may be planar or may be curved in one or more dimensions. If desired, the substrate and antenna elements 100 may be enclosed within a housing. The housing may be formed from materials that are transparent to THF signals 32. If desired, RIS 96 may be disposed (e.g., layered) onto an underlying electronic device. RIS 96 may also be provided with mounting structures (e.g., adhesive, brackets, a frame, screws, pins, clips, etc.) that can be used to affix or attach RIS 96 to an underlying structure such as another electronic device, a wall, the ceiling, the floor, furniture, etc. Disposing RIS 96 on a ceiling, wall, column, pillar, or at or adjacent to the corner of a room (e.g., a corner where two walls intersect, where a wall intersects with the floor or ceiling, where two walls and the floor intersect, or where two walls and the ceiling intersect), as examples, may be particularly helpful in allowing RIS 96 to reflect THF signals between AP 6 and UE 10 around various objects 94 that may be present within the room.

RIS 96 may be a powered device that includes control circuitry (e.g., one or more processors) that help to control the operation of array 98 (e.g., control circuitry such as control circuitry 14 of FIG. 1). When electro-magnetic (EM) energy waves (e.g., waves of THF signals 32) are incident on RIS 96, the wave is effectively reflected by each antenna element 100 in array 98 (e.g., via re-radiation by each antenna element 100 with a respective phase and amplitude response). The control circuitry on RIS 96 may determine the response on a per-element or per-group-of-elements basis (e.g., where each antenna element has a respective programmed phase and amplitude response or the antenna elements in different sets/groups of antenna elements are each programmed to share the same respective phase and amplitude response across the set/group but with different phase and amplitude responses between sets/groups). The scattering, absorption, reflection, and diffraction properties of the entire RIS can therefore be changed over time and controlled (e.g., by software running on the RIS or other devices communicably coupled to the RIS such as AP 6 or UE device 10). One way of achieving the per-element phase and amplitude response of antenna elements 100 is by adjusting the impedance of antenna elements 100, thereby controlling the complex reflection coefficient that determines the change in amplitude and phase of the re-radiated signal. The control circuitry on RIS 96 may configure antenna elements 100 to exhibit impedances (or other properties) that serve to reflect THF signals 32 incident from particular incident angles onto particular output angles. The antenna elements (e.g., the antenna impedances) may be adjusted to change the angle with which incident THF signals 32 are reflected off of RIS 96.

For example, the control circuitry on RIS 96 may configure array 98 to reflect THF signals 32 transmitted by AP 6 towards UE device 10 and to reflect THF signals 32 transmitted by UE device 10 towards AP 6. This may effectively cause the signal beam 82 between AP 6 and UE device 10 to form a reflected signal beam having a first portion 82A from AP 6 to RIS 96 and a second portion 82B from RIS 96 to UE device 10. To convey THF signals 32 over the reflected signal beam, phased antenna array 88′ on AP 6 may perform beamforming (e.g., by configuring its antennas 30′ with respective beamforming coefficients as given by an AP codebook at AP 6) to form an AP beam (sometimes referred to herein as an AP signal beam) with a beam pointing direction oriented towards RIS 96 (e.g., as shown by portion 82A of the signal beam) and phased antenna array 88 on UE device 10 may perform beamforming (e.g., by configuring its antennas 30 with respective beamforming coefficients as given by a UE codebook at UE device 10) to form a UE beam (sometimes referred to herein as a UE signal beam) with a beam pointing direction oriented towards RIS 96 (e.g., as shown by portion 82B of the signal beam).

At the same, RIS 96 may configure its own antenna elements 100 to perform beamforming with respective beamforming coefficients (e.g., as given by a RIS codebook at RIS 96). The beamforming performed at RIS 96 may include two concurrently active RIS beams (e.g., where each RIS beam is generated using a corresponding set of beamforming coefficients). RIS 96 may form a first RIS beam (referred to herein as a RIS-AP beam) that has a beam pointing direction oriented towards AP 6 and may concurrently form a second RIS beam (referred to herein as a RIS-UE beam) that has a beam pointing direction oriented towards UE device 10. In this way, when THF signals 32 are incident from AP 6 (e.g., within portion 82A of the signal beam), the antenna elements on RIS 96 may receive the THF signals incident from the direction of AP 6 and may re-radiate (e.g., effectively reflect) the incident THF signals 32 towards the direction of UE device 10 (e.g., within portion 82B of the signal beam). Conversely, when THF signals 32 are incident from UE device 10 (e.g., within portion 82B of the signal beam), the antenna elements on RIS 96 may receive the THF signals incident from the direction of UE device 10 and may re-radiate (e.g., effectively reflect) the incident THF signals 32 towards the direction of AP 6 (e.g., within portion 82A of the signal beam). While referred to herein as “beams,” the RIS-UE and RIS-AP beams formed by RIS 96 do not include signals/data that are actively transmitted by RIS 96 but instead correspond to the impedance, phase, and/or magnitude response settings for antenna elements 100 that shape the reflected signal beam of THF signals from a corresponding incident direction/angle onto a corresponding output direction/angle (e.g., the RIS-UE beam may be effectively formed using a first set of beamforming coefficients and the RIS-AP beam may be effectively formed using a second set of beamforming coefficients but are not associated with the active transmission of wireless signals by RIS 96). Put differently, each RIS beam may correspond to a different respective set of reflection coefficients for the antenna elements in the RIS (e.g., as set using adjustable devices such as phase shifters or diodes coupled to the antenna elements) rather than an active beam of transmitted signals.

The control circuitry on RIS 96 may set and adjust the impedances (or other characteristics) of antenna elements 100 in array 98 to reflect THF signals 32 in desired directions (e.g., using a data transfer RAT associated with communications at the frequencies of THF signals 32). The control circuitry on RIS 96 may communicate with AP 6 and/or UE device 10 using radio-frequency signals at lower frequencies using a control RAT that is different than the data transfer RAT. The control RAT may be used to help control the operation of array 98 in reflecting THF signals 32 and may be used to convey any desired control signals between AP 6, RIS 96, and UE device 10 (e.g., control signals that are separate from the wireless data conveyed between AP 6 and UE device 10 using the data transfer RAT). For example, the control RAT may allow AP 6, UE device 10, and/or RIS 96 to interact with each other before a THz link is established over the data transfer RAT, e.g., to set up, establish, and maintain the THz link with the data transfer RAT, to coordinate control procedures between AP 6 and UE device 10 such as beam sweeping or beam tracking, etc. RIS 96 may include transceiver circuitry and the control circuitry on RIS 96 may include one or more processors that handle communications using the control RAT. One or more antenna elements 100 on RIS 96 may be used to convey radio-frequency signals using the control RAT or RIS 96 may include one or more antennas that are separate from array 98 for performing communications using the control RAT.

To minimize the cost, complexity, and power consumption of RIS 96, RIS 96 may include only the components and control circuitry required to control and operate array 98 to reflect THF signals 32. Such components and control circuitry may include components for adjusting the phase and magnitude responses (e.g., impedances) of antenna elements 100 as required to change the direction with which RIS 96 reflects THF signals 32 (e.g., as required to steer the RIS-AP beam and the RIS-UE beam, as shown by arrows 102). The components may include, for example, components that adjust the impedances or other characteristics of antenna elements 100 so that each antenna element exhibits a respective complex reflection coefficient, which determines the phase and amplitude of the reflected (re-radiated) signal produced by each antenna element (e.g., such that the signals reflected across the array constructively and destructively interfere to form a reflected signal beam in a corresponding beam pointing direction). All other components that would otherwise be present in UE device 10 or AP 6 may be omitted from RIS 96 (e.g., other processing circuitry, input/output devices such as a display or user input device, transceiver circuitry for generating and transmitting, receiving, or processing wireless data conveyed using THF signals 32, etc.). In other words, the control circuitry on RIS 96 may adjust the antenna elements 100 in array 98 to shape the electromagnetic waves of THF signals 32 (e.g., reflected/re-radiated THF signals 32) for the data transfer RAT without using antenna elements 100 to perform any data transmission or reception operations and without using antenna elements 100 to perform radio-frequency sensing operations. RIS 96 may also include components for communicating using the control RAT.

As one example, array 98 may be implemented using the components of phased antenna array 88 of FIG. 7. However, since RIS 96 does not actually generate or transmit wireless data using array 98 and the data transfer RAT, antenna elements 100 may be implemented without modulators, without a receiver, without a transmitter, without converter circuitry, without mixer circuitry, and/or without other circuitry involved in the transmission or reception of wireless data. If desired, each antenna element 100 may include a respective varactor diode or other impedance-adjusting device that is coupled to a corresponding antenna resonating element. The varactor diode or other impedance-adjusting device may be adjusted using control signals to adjust the impedance of the antenna element to change the phase/amplitude of the THF signals reflected by the antenna element for performing beamforming (e.g., antenna elements 100 may reflect THF signals 32 without the use of optical local oscillator signals, thereby allowing RIS 96 to also omit the LO light sources 70 and signal path 28 (FIG. 6), which may otherwise be implemented in UE device 10 and/or AP 6, to further reduce cost, complexity, and power consumption).

Consider an example in which each antenna element 100 includes a respective antenna resonating element 36 and UTC PD 42 as in antenna 30 of FIGS. 2-7. In this example, UTC PD 42 need not be supplied with optical local oscillator signals because antenna element 100 is only used for passive signal reflection and not for active signal transmission or reception. Control signals V_{BIAS} may include a bias voltage and/or other control signals that configure UTC PD 42 to exhibit a selected output impedance. UTC PD 42 may also be replaced with a varactor diode or other impedance-adjusting device configured to adjust the output impedance. The selected output impedance may be mismatched with respect to the input impedance of antenna resonating element 36 (e.g., at the frequencies of THF signals 32). This impedance mismatch may cause antenna element 100 to reflect (scatter) incident THF signals 32 as reflected (scattered) THF signals (e.g., with a corresponding complex reflection coefficient).

The selected impedance mismatch may also configure antenna element 100 to impart a selected phase shift and/or carrier frequency shift on the reflected THF signals relative to the incident THF signals 32 (e.g., where the reflected THF signals are phase-shifted with respect to THF signals 32 by the selected phase shift, are frequency-shifted with respect to THF signals 32 by the selected carrier frequency shift, etc.). Additionally or alternatively, the system may be adapted to configure antenna element 100 to impart polarization changes on the reflected THF signals relative to the incident THF signals 32. Control signals V_{BIAS} may change, adjust, or alter the output impedance of UTC PD 42 (or the varactor diode or other impedance-adjusting device) over time to change the amount of mismatch between the output impedance of UTC PD 42 (or the varactor diode or other device) and the input impedance of antenna resonating element 36 to impart the reflected THF signals with different phase shifts and/or carrier frequency shifts. In other words, control circuitry on RIS 96 (e.g., control circuitry with similar components and/or functionality as control circuitry 14 of FIG. 1) may program the phase, frequency, and/or polarization characteristics of the reflected THF signals (e.g., using the control signals V_{BIAS} applied to UTC PD 42, the varactor diode, or other device).

The same impedance mismatch may be applied to all the antenna elements 100 in array 98 or different impedance mismatches may be applied for different antennas elements 100 in array 98 at any given time. Applying different impedance mismatches across array 98 may, for example, allow the control circuitry in RIS 96 to form a RIS-UE beam and a RIS-AP beam that points in one or more desired (selected) beam pointing directions. This example in which control signal V_{BIAS} is used to adjust antenna impedance using UTC PD 42 is merely illustrative. In general, antenna elements 100 may be implemented using any desired antenna architecture (e.g., the antennas need not include photodiodes) and may include any desired structures that are adjusted by control circuitry (e.g., using control signals V_{BIAS} or other control signals) on RIS 96 to impart the THF signals 32 reflected by each antenna element 100 with a different relative phase such that the THF signals reflected by all antenna elements 100 collectively form a reflected signal beam (e.g., a RIS-UE beam or a RIS-AP beam) oriented in a desired (selected) beam pointing direction. Such structures (e.g., impedance-adjusting devices) may include adjustable impedance matching structures or circuitry, varactor diodes, adjustable phase shifters, adjustable amplifiers, optical phase shifters, antenna tuning elements, and/or any other desired structures that may be used to change the amount of impedance mismatch produced by antenna elements 100 at the frequencies of THF signals 32.

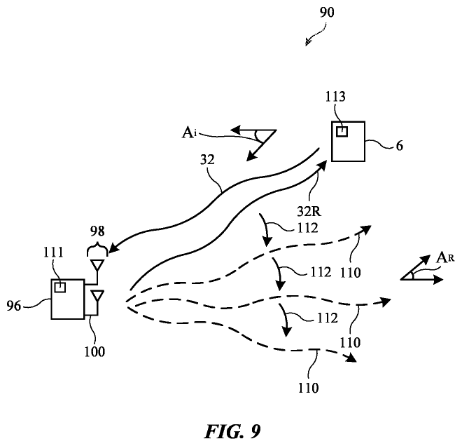

FIG. 9 is a diagram showing how two or more antenna elements 100 on RIS 96 (e.g., array 98) may reflect incident THF signals 32 transmitted by AP 6. As shown in FIG. 9, AP 6 may transmit THF signals 32. THF signals 32 may be incident upon RIS 96 at incident angle Aᵢ. Antenna elements 100 in array 98 may reflect the THF signals 32 at incident angle Aᵢ as reflected signals 32R. Control signals V_{BIAS} may be varied (e.g., thereby varying imparted phase shift) across array 98 to configure array 98 to collectively reflect THF signals 32 from incident angle Aᵢ onto a corresponding output (scattered) angle A_{R} (e.g., as a reflected signal beam with a beam pointing direction in the direction of output angle A_{R}).

Control signals V_{BIAS} may configure output angle A_{R} to be any desired angle within the field of view of RIS 96. For example, output angle A_{R} may be oriented towards AP 6 so AP 6 receives reflected signals 32R. This may allow AP 6 to identify the position and orientation of RIS 96 (e.g., in situations where AP 6 has no a priori knowledge of the location and orientation of device RIS 96). If desired, control circuitry on RIS 96 may control output angle A_{R} to point in other directions, as shown by arrows 110. Arrows 110 may be oriented towards UE device 10 (e.g., as a part of signal beam 82B of FIG. 8). If desired, UE device 10 may identify the location and orientation of RIS 96 based on receipt of reflected signals 32R. If desired, the control circuitry on RIS 96 may sweep reflected signals 32R over a number of different output angles A_{R} as a function of time, as shown by arrows 112. This may, for example, help RIS 96 to establish a THF signal relay between UE device 10 and AP 6, to find other UE devices for relaying THF signals, and/or to maintain a THF signal relay between UE device 10 and AP 6 even as UE device 10 and/or object 94 (FIG. 8) move over time. The example of FIG. 9 is merely illustrative. Signals 32 may be reflected in three dimensions. RIS 96 may reflect signals transmitted by UE device 10 towards AP 6 while implementing beam steering.

In practice, AP 6 and RIS 96 are generally stationary within environment 90, whereas UE device 10 and object 94 may move over time. It can be challenging to initiate communications between AP 6 and UE device 10 via RIS 96 in this type of environment, particularly because AP 6 needs to know the relative position and orientation of RIS 96 to correctly form its AP signal beam, UE device 10 needs to know the relative position and orientation of RIS 96 to correctly form its UE signal beam, and AP 6 or UE device 10 needs to know the relative position and orientation of RIS 96 to control RIS 96 (e.g., via the control RAT) to correctly form its RIS-AP beam and RIS-UE beam. However, AP 6 and UE device 10 have no a priori knowledge of the relative position and orientation of RIS 96 prior to beginning THF communications via RIS 96.

The relative position and orientation of RIS 96 may, for example, be defined by six degrees of freedom: three translational positions along the X, Y, and Z axes of FIG. 8 and three rotational positions such as tilt (pitch), rotation (roll), and yaw, as shown by arrows 104, 106, and 108 of FIG. 8). In some scenarios, RIS 96 may include sensors (e.g., accelerometers, gyroscopes, compasses, image sensors, light sensors, radar sensors, acoustic sensors, etc.) that identify the relative position and orientation of RIS 96. In these scenarios, RIS 96 may use the control RAT to inform AP 6 and/or UE device 10 of the relative position and orientation. However, including such sensors on RIS 96 would undesirably increase the cost, complexity, and power consumption of RIS 96. It would therefore be desirable to be able to establish and maintain THF communications between UE device 10 and AP 6 via RIS 96 without the use of such sensors on RIS 96.

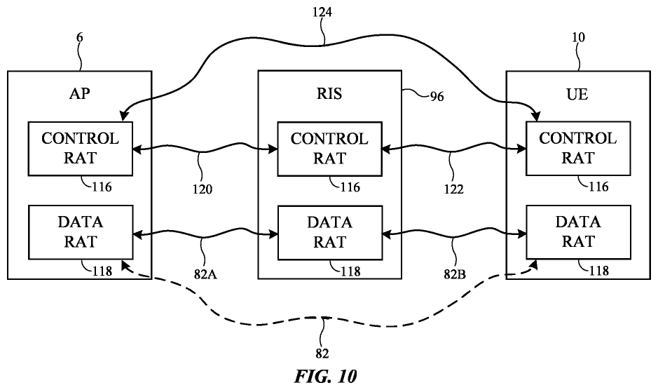

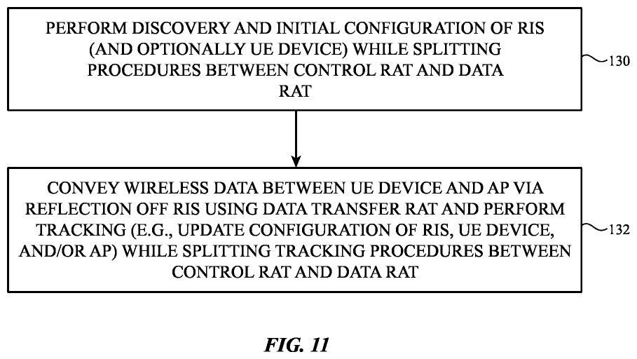

FIG. 10 is a diagram showing how AP 6, RIS 96, and UE device 10 may communicate using both a control RAT and a data transfer RAT for establishing and maintaining communications between AP 6 and UE device 10 via RIS 96. As shown in FIG. 10, AP 6, RIS 96, and UE device 10 may each include wireless circuitry that operates according to a data transfer RAT 118 (sometimes referred to herein as data RAT 118) and a control RAT 116. Data RAT 118 may be a sub-THz communications RAT such as a 6G RAT that performs wireless communications at the frequencies of THF signals 32. Control RAT 116 may be associated with wireless communications that consume much fewer resources and are less expensive to implement than the communications of data RAT 118. For example, control RAT 116 may be Wi-Fi, Bluetooth, a cellular telephone RAT such as a 3G, 4G, or 5G NR FR1 RAT, etc. As another example control RAT 116 may be an infrared communications RAT (e.g., where an infrared remote control or infrared emitters and sensors use infrared light to convey signals for the control RAT between UE device 10, AP 6, and/or RIS 96).

AP 6 and RIS 96 may use control RAT 116 to convey radio-frequency signals 120 (e.g., control signals) between AP 6 and RIS 96. UE device 10 and RIS 96 may use control RAT 116 to convey radio-frequency signals 122 (e.g., control signals) between UE device 10 and RIS 96. UE device 10, AP 6, and RIS 96 may use data RAT 118 to convey THF signals 32 within the reflected signal beam (e.g., within portion 82A between AP 6 and RIS 96 and portion 82B between RIS 96 and UE device 10). The RIS-UE beam and the RIS-AP beam formed by RIS 96 may operate on THF signals transmitted using data RAT 118 to reflect the THF signals between AP 6 and UE device 10. AP 6 may use radio-frequency signals 120 and control RAT 116 and/or UE device 10 may use radio-frequency signals 122 and control RAT 116 to discover RIS 96 and to configure antenna elements 100 to establish and maintain the relay of THF signals 32 performed by antenna elements 100 using data RAT 118.

If desired, AP 6 and UE device 10 may also use control RAT 116 to convey radio-frequency signals 124 directly with each other (e.g., since the control RAT operates at lower frequencies that do not require line-of-sight). UE device 10 and AP 6 may use radio-frequency signals 124 to help establish and maintain THF communications (communications using data RAT 118) between UE device 10 and AP 6 via RIS 96. AP 6 and UE device 10 may also use data RAT 118 to convey THF signals 32 within an uninterrupted signal beam 82 (e.g., a signal beam that does not reflect off RIS 96) when LOS path 92 (FIG. 8) is available. If desired, the same control RAT 116 may be used to convey radio-frequency signals 120 between AP 6 and RIS 96 and to convey radio-frequency signals 122 between RIS 96 and UE device 10. If desired, AP 6, RIS 96, and/or UE device 10 may support multiple control RATs 116. In these scenarios, a first control RAT 116 (e.g., Bluetooth) may be used to convey radio-frequency signals 120 between AP 6 and RIS 96, a second control RAT 116 (e.g., Wi-Fi) may be used to convey radio-frequency signals 122 between RIS 96 and UE device 10, and/or a third control RAT 116 may be used to convey radio-frequency signals 124 between AP 6 and UE device 10.

Processing procedures (e.g., work responsibilities) may be divided between data RAT 118 one or more control RAT 116 during discovery, initial configuration, data RAT communication between UE device 10 and AP 6 via RIS 96, and beam tracking of UE device 10. FIG. 11 is a flow chart of illustrative operations that may be performed by UE device 10 and AP 6 to communicate via RIS 96 while splitting procedures between control RAT 116 and data RAT 118.

At operation 130, AP 6, UE device 10, and/or RIS 96 may perform discovery while splitting procedures (e.g., processing responsibilities) between control RAT 116 and data RAT 118. Discovery may involve AP 6, UE device 10, and/or RIS 96 becoming aware of each other and/or their respective capabilities. AP 6, UE device 10, and/or RIS 96 may also perform an initial configuration of RIS 96 while splitting procedures between control RAT 116 and data RAT 118. The initial configuration may involve generating an AP-RIS configuration and an UE-RIS configuration, configuring AP 6 and RIS 96 using the AP-RIS configuration, and configuring RIS 96 and UE device 10 using the UE-RIS configuration. The AP-RIS configuration may include initial settings to support the conveyance of THF signals 32 (using the data RAT) between AP 6 and RIS 96 (e.g., in using RIS 96 to reflect the THF signals between AP 6 and UE device 10).

The AP-RIS configuration may, for example, include an AP beam for AP 6 that is oriented towards RIS 96 and a RIS-AP beam for RIS 96 that is oriented towards AP 6. When configured using the AP-RIS configuration, AP 6 may form the AP beam and RIS 96 may form the RIS-AP beam. The UE-RIS configuration may include initial settings to support the conveyance of THF signals 32 (using the data RAT) between UE device 10 and RIS 96 (e.g., in using RIS 96 to reflect the THF signals between AP 6 and UE device 10). The UE-RIS configuration may, for example, include a UE beam for UE device 10 that is oriented towards RIS 96 and a RIS-UE beam for RIS 96 that is oriented towards UE device 10. When configured using the UE-RIS configuration, UE device 10 may form the UE beam and RIS 96 may form the RIS-UE beam. The generation of the AP-RIS configuration, the generation of the UE-RIS configuration, implementation of the AP-RIS configuration on AP 6 and RIS 96, and implementation of the UE-RIS configuration on UE device 10 and RIS 96 may be split between control RAT 116 and data RAT 118, as described in further detail below.

At operation 132, AP 6 and UE device 10 may use data RAT 118 to convey wireless data via THF signals 32 that are reflected off RIS 96. AP 6, UE device 10, and/or RIS 96 may concurrently perform beam tracking while splitting procedures for beam tracking between control RAT 116 and data RAT 118. The beam tracking may involve updating the AP-RIS configuration and/or updating the UE-RIS configuration to account for changes in the position or orientation of UE device 10, RIS 96, and/or AP 6.

In most cases, AP 6 and RIS 96 remain at fixed positions in the environment. This will be assumed for the sake of simplicity hereinafter. However, in general, beam tracking may involve updating the AP-RIS configuration (e.g., updating the active AP beam and/or the active RIS-AP beam) using control RAT 116 and/or data RAT 118 using similar procedures to updating the UE-RIS configuration as described hereinafter (e.g., when AP 6 and/or RIS 96 moves or rotates over time). Under the assumption that AP 6 and RIS 96 remain in fixed positions, the beam tracking may involve only updating the UE-RIS configuration using control RAT 116 and data RAT 118. Updating the UE-RIS configuration may involve updating the active UE beam and/or the active RIS-UE beam to account for the mobility of UE device 10 (e.g., to continue to provide data RAT coverage of UE device 10 via RIS 96 as UE device 10 moves or rotates over time). This may allow RIS 96 to continue to “track” UE device 10 using its RIS-UE beam so RIS 96 can continue to reflect THF signals 32 between UE device 10 and AP 6 over time.

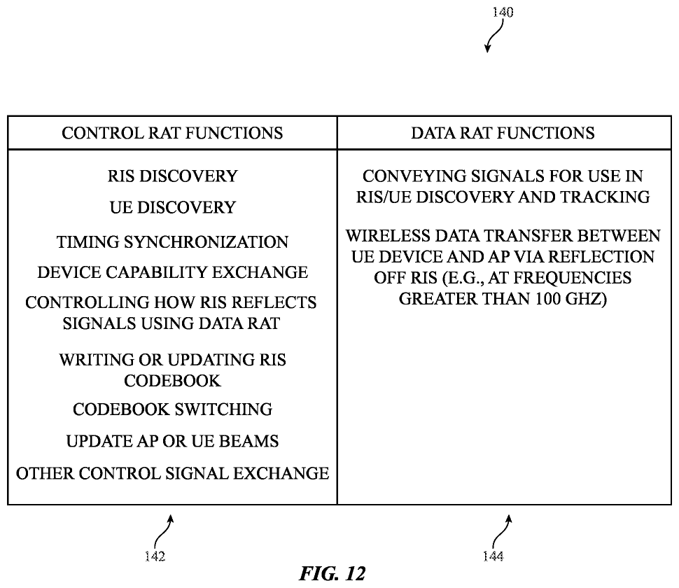

FIG. 12 shows a table 140 that illustrates different operations that may be performed using control RAT 116 or using data RAT 118 during discovery, initial configuration, data transfer, and tracking performed by AP 6, UE device 10, and RIS 96 (e.g., while processing the operations of FIG. 1). Column 142 of table 140 lists exemplary control RAT functions that may be performed using control RAT 116. Column 144 of table 140 lists exemplary data RAT functions that may be performed using data RAT 118.

As shown by column 142, the control RAT functions may include RIS discovery. RIS discovery involves the discovery of RIS 96 by AP 6 and/or UE device 10 of RIS. RIS discovery may also involve the discovery of one or more capabilities of RIS 96 by AP 6 and/or UE device 10 (e.g., RIS 96 may transmit a unique identifier identifying RIS 96 and optionally capability identifiers identifying one or more capabilities of RIS 96 to UE device 10 and/or AP 6 using control RAT 116).

As one example, the capability identifiers may include a capability identifier indicating the number of programmable antenna elements 100 on RIS 96 or the number of groups of programmable antenna elements 11 (e.g., in scenarios where not all antenna elements 100 have a programmable impedance or phase, this capability identifier may identify which of the antenna elements 100 are programmable, which are not programmable, etc.). As another example, the capability identifiers may include information identifying the geometry of RIS 96 and/or of array 98. As yet another example, the capability identifiers may include an identifier indicating the number of programmable codebooks 111 (FIG. 9) accessible via codebook index on RIS 96 and/or other information identifying one or more entries of codebook 111. This information may include information on how many codebook indices there are in the vertical direction and in the horizontal direction in codebook 111. As another example, the capability identifiers may identify the amplitudes, phases, and/or polarizations that are available for each of the programmable antenna elements 100 in array 98 (e.g., amplitude bits, phase bits, and/or polarization bits that can be used by RIS 96 to control the amplitude, phase, and/or polarization of THF signals reflected by antenna elements 100). If desired, the capability identifiers may include the speed with which RIS 96 is able to change its reflective response (e.g., the time required by RIS 96 to change the state/configuration of its antenna elements 100 and thus its reflected beam angle). As another example, the capability identifiers may include information identifying the timing synchronization procedures of RIS 96 and/or the accuracy of timing synchronization at RIS 96. As yet another example, the capability identifiers may include information about supported autonomous RIS signal beam variation procedures and associated parameters. These examples are merely illustrative and, in general, RIS 96 may transmit any desired capability identifiers to AP 6. RIS discovery may be performed upon power-up of RIS 96, periodically, when UE device 10 or AP 6 enter the vicinity of RIS 96, when RIS 96 enters the vicinity of UE device 10 or AP 6, etc.

As shown by column 142, the control RAT functions may include UE discovery. UE discovery involves the discovery of UE device 10 by AP 6 and/or RIS 96. UE discovery may also involve the discovery of one or more capabilities of UE device 10 by AP 6 and/or RIS 96 (e.g., UE device 10 may transmit one or more capability identifiers to AP 6 and/or RIS 96 via the control RAT) and/or the discovery of one or more capabilities of AP 6 by UE device 10 (e.g., AP 6 may use the control RAT to transmit one or more capability identifiers to UE device 10 and/or RIS 96). UE discovery via control RAT 116 may, for example, be performed when UE device 10 enters the vicinity of AP 6 and/or RIS 96 but does not have a LOS path to AP 6, which prevents UE device 10 from being able to inform AP 6 of its presence using data RAT 118 (e.g., for scheduling communications between UE device and the rest of the network via AP 6). Control RAT 116, which does not require a LOS path, may therefore allow UE device 10 to inform AP 6 of its presence so AP 6 can begin to schedule communications for UE device 10 with the rest of the network over data RAT 118.

The control RAT functions may also include timing synchronization. Control RAT 116 may, for example, be used to transmit control signals that synchronize the timing of AP 6 to the timing of UE device 10 and the timing of RIS 96. Timing synchronization may allow AP 6 or UE device 10 to then schedule communications in a time-synchronized manner Timing synchronization may also allow AP 6 and/or UE to control updates to the beamforming of RIS 96, UE device 10, and/or AP 6 in a time-synchronized manner

The control RAT functions may also include controlling how RIS 96 reflects THF signals 32 transmitted over data RAT 118. This may include updating the AP-RIS configuration and/or the AP-UE configuration. For example, AP 6 and/or UE device 10 may use the control RAT to transmit control signals to RIS 96 that instruct RIS 96 to change the settings for antennas 100. This may include programming RIS 96 (e.g., using corresponding beamforming coefficients) to update its RIS-UE beam to track UE device 10. AP 6 may use the control RAT to transmit control signals to UE device 10 to change the settings for antennas 30 (e.g., to update its UE beam). In other implementations, UE device 10 may update its own UE beam to track RIS 96 as UE device 10 moves or rotates. If desired, UE device 10 may use the control RAT to transmit control signals to AP 6 to change the settings for antennas 30′ (e.g., to update its AP beam). AP 6 and/or UE device 10 may also use the control RAT to control RIS 96 to update its RIS-AP beam (e.g., in scenarios where AP 6 or RIS 96 are not fixed in place).

If desired, AP 6 and/or UE device 10 may use control RAT 116 to write one or more entries in the codebook 111 on RIS 96 (FIG. 9). AP 6 and/or UE device 10 may use control RAT 116 to populate the entirety of codebook 111 (e.g., upon discovery of RIS 96), may copy some or all of the codebook of AP 6 or UE device 10 into codebook 111, or may actively update one or more entries of codebook 111 (e.g., to add or replace RIS-UE beams and/or RIS-AP beams oriented in different selected directions to codebook 111 as needed over time). Codebook 111 may, if desired, be generated and populated in-factory and then updated as needed by AP 6 and/or UE device 10 via the control RAT. In a manual mode, AP 6 and/or UE device 10 may use control RAT 116 to program the phase and magnitude settings (e.g., the corresponding beamforming coefficient) for each antenna element 100 in RIS 96 to configure RIS 96 to form optimal RIS-UE beams and/or RIS-AP beams (e.g., in scenarios where the factory-stored RIS beams are suboptimal for reflecting THF signals to the location of UE device 10).

If desired, AP 6 and/or UE device 10 may use control RAT 116 to control, coordinate, and/or perform codebook switching on RIS 96. RIS 96 may, for example, include multiple codebooks 111. AP 6 and/or UE device 10 may use control RAT 116 to instruct RIS 96 to activate a selected one of its codebooks 111 at a given time (e.g., so the entries of the selected codebook are used for beamforming to form RIS-AP beams and RIS-UE beams). Codebook switching may be performed via a control RAT command issued by AP 6 and/or UE device 10 or via a control RAT timing synchronization message transmitted by AP 6 and/or UE device 10.

In multi-user implementations, RIS 96 may reflect THF signals between AP 6 and multiple UE devices 10. For example, a first UE device may be at a first location and a second UE device may be at a second location with respect to RIS 96. RIS 96 may have a first RIS-UE beam oriented towards the first UE device and may have a second RIS-UE beam oriented towards the second UE device. The first and second RIS-UE beams may be defined by the same codebook 111 or may be defined by separate codebooks 111. If desired, AP 6 may use control RAT 116 to instruct RIS 96 when and how to switch between the first RIS-UE beam for conveying THF signals 32 to the first UE device and the second RIS-UE beam for conveying THF signals 32 to the second UE device (e.g., AP 6 may control the timing with which RIS 96 services the first UE device or the second UE device). In examples where the first RIS-UE beam and the second RIS-UE beam are defined by separate codebooks 111, AP 6 may use the control RAT to instruct RIS 96 when and how to switch between the codebooks for servicing the first UE device or the second UE device.

As shown by column 144, the data RAT functions of data RAT 118 include the conveyance of wireless data using THF signals 32 between AP 6 and UE device 10 via reflection off RIS 96 (e.g., at frequencies greater than 100 GHz). The data RAT functions may also include the conveyance of other THF signals 32 between AP 6 and UE device 10 such as reference signals (e.g., a series of reference symbols), radar waveforms, or any other desired THF waveforms that are reflected off RIS 96. The reference signals conveyed using data RAT 118 may be used to perform discovery on RIS 96 and/or UE device 10 and/or may be used to perform tracking once an initial configuration has already been established. For example, UE device 10 may measure the reference signals transmitted by AP 6 and reflected off RIS 96 while RIS 96 sweeps over RIS-UE beams and/or while UE device 10 sweeps over UE beams. UE device 10 may gather wireless performance metric information from the measured reference signals and may use the wireless performance metric information to generate and implement the UE-RIS configuration and/or to perform beam tracking (e.g., to update the UE-RIS configuration).

UE device 10 may, for example, set its own UE beam and/or may use the control RAT to set the RIS-UE beam based on the wireless performance metric data (e.g., in implementing the initial UE-RIS configuration at operation 130 of FIG. 11). Additionally or alternatively, UE device 10 may update its UE beam and/or may use the control RAT to update the RIS-UE beam based on the wireless performance metric data (e.g., to update the UE-RIS configuration while performing tracking at operation 132 of FIG. 11). The AP beam and RIS-UE beam selected by UE device 10 may be beams for which peak or optimal wireless performance metric data was gathered, for example. AP 6 may also use reference signals that have reflected off RIS 96 while RIS 96 sweeps over RIS-AP beams and/or while AP 6 sweeps over RIS beams to gather wireless performance metric data. AP 6 may then set its own AP beam and/or may use the control RAT to set the RIS-AP beam based on the wireless performance metric data (e.g., in implementing the initial UE-RIS configuration at operation 130 of FIG. 11). Additionally or alternatively, UE device 10 may update its AP beam and/or may use the control RAT to update the RIS-AP beam based on the wireless performance metric data (e.g., to update the AP-RIS configuration while performing tracking at operation 132 of FIG. 11). The AP beam and RIS-UE beam selected by UE device 10 may be beams for which peak or optimal wireless performance metric data was gathered, for example.

The example of FIG. 12 is merely illustrative. One or more of the control RAT functions in FIG. 12 may be omitted. Additional control RAT functions may be performed over control RAT 116 if desired. The control RAT functions (operations) of column 142 may be performed using multiple different control RATs if desired. In situations where the RIS 96 has not yet been configured by AP 6 or UE device 10 over the control RAT, RIS 96 may apply random settings (e.g., random phase shifts, magnitudes, impedances, beamforming coefficients, etc.) across its antenna elements 100. This may serve to prevent unintended THF reflections off of RIS 96. If desired, RIS 96 may apply random settings across its antenna elements 100 when powering off to prevent unintended THF reflections off RIS 96 while the RIS is powered off (e.g., antenna elements 100 may retain their settings and may still reflect electromagnetic energy after RIS 96 has been powered off).

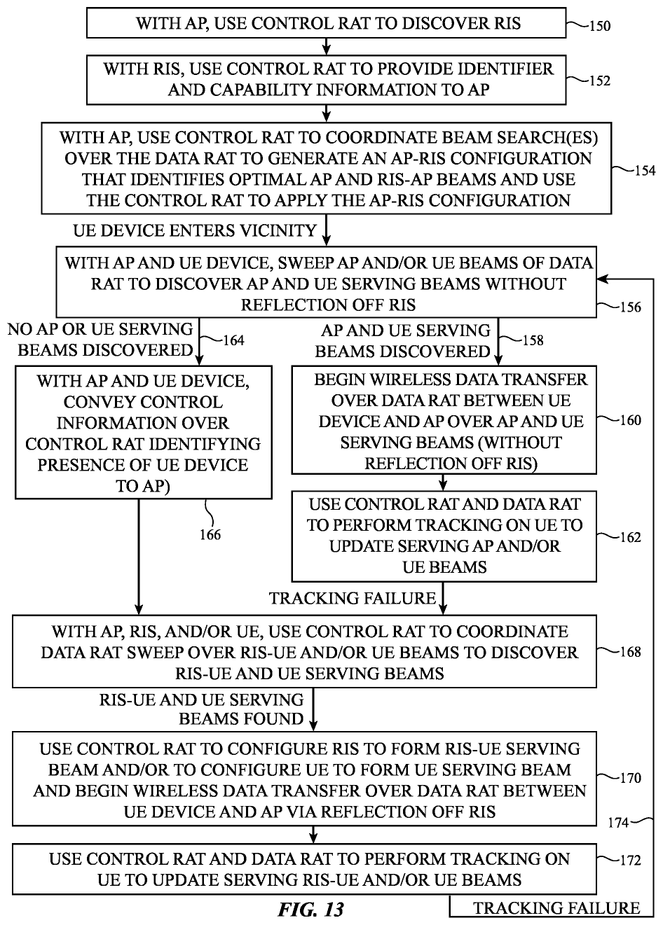

FIG. 13 is a flow chart illustrating one example of how AP 6, UE device 10, and RIS 96 may split procedures between control RAT 116 and data RAT 118 during discovery, initial configuration, wireless data transfer, and tracking. The operations of FIG. 13 may, for example, be performed while processing operations 130-132 of FIG. 11. The operations of FIG. 13 may, for example, involve performing one or more of the control RAT functions shown in column 142 of FIG. 12 over control RAT 116 and one or more of the data RAT functions shown in column 142 of FIG. 12 over data RAT 118.

At operation 150, AP 6 may use control RAT 116 to discover RIS 96 (e.g., AP 6 may perform control RAT discovery on RIS 96). Operation 150 may, for example, be performed upon power up of RIS 96 or when RIS 96 enters the vicinity of AP 6. RIS 96 may, for example, use control RAT to transmit signals (e.g., upon power up of RIS 96) that are received by AP 6. AP 6 may use the control RAT to transmit a corresponding acknowledgement signal to RIS 96 (e.g., the control RAT may be used to perform a handshake procedure). Additionally or alternatively, AP 6 may use the control RAT to transmit a signal, RIS 96 may receive the signal, and RIS 96 may use the control RAT to transmit an acknowledgement signal to AP 6.

At operation 152, RIS 96 may use control RAT 116 to transmit control information to AP 6. The control information may include a RIS identifier. The RIS identifier may include a unique identification number (e.g., a globally unique identifier) associated with RIS 96. Additionally or alternatively, RIS 96 may use control RAT 116 to transmit one or more capability identifiers to AP 6. AP 6 may store the RIS identifier and the capability identifiers for later processing. AP 6 may, for example, use the RIS identifier and the capability identifiers in performing data transfer RAT discovery procedures and/or in establishing/maintaining THz communications between UE device 10 and AP 6 via RIS 96. At this point, AP 6 has knowledge that RIS 96 is present within environment 90 as well as the capabilities of RIS 96.

At operation 154, AP 6 may use control RAT 116 to coordinate beam searches between AP 6 and RIS 96 over data RAT 118 (e.g., AP 6 may perform data RAT discovery with RIS 96). The beam searches may involve AP 6 beginning to transmit THF signals to RIS 96 over the data RAT. The beam searches may also involve AP 6 using control RAT 116 to transmit control signals that instruct RIS 96 to perform part of the beam searches. The beam searches may be performed to identify an AP-RIS configuration. Once the AP-RIS configuration has been identified, AP 6 may implement the AP-RIS configuration using control RAT 116.

In general, phased antenna array 88′ on AP 6 may be able to form a set of different AP beams, where each AP beam in the set is oriented in a different beam pointing direction. Each AP beam may be defined by a corresponding AP beam index m_{AP}. AP 6 may have a codebook 113 (FIG. 9) that identifies the settings (e.g., beamforming coefficients, phase settings, impedance settings, magnitude settings, etc.) for each antenna 30′ in phased antenna array 88′ corresponding to each AP beam index m_{AP} (e.g., codebook 113 may store the settings for each antenna 30′ to form each AP beam in the set of formable AP beams). Codebook 113 may be hardcoded and/or soft-coded on AP 6 (e.g., codebook 113 may include a table, database, register, or other data object stored on AP 6).

In general, array 98 on RIS 96 may be able to form a set of different RIS-AP signal beams each oriented in a different respective direction and may be able to concurrently form a set of different RIS-UE beams each oriented in a different respective direction. RIS 96 may, for example, concurrently form one of the RIS-AP signal beams in the set of RIS-AP signal beams and one of the RIS-UE signal beams in the set of RIS-UE signal beams The signal beams formed by RIS 96 at any given instant may sometimes be referred to herein as active beams Each RIS-UE beam in the set of RIS-UE beams formable by RIS 96 may be defined or labeled by a corresponding RIS-UE beam index. Similarly, each RIS-AP beam in the set of RIS-AP beams may be defined or labeled by a corresponding RIS-AP beam index. The settings for antenna elements 98 that are used to form the RIS-UE and RIS-AP beams (e.g., beamforming coefficients, phase settings, magnitude settings, impedance settings, etc.) and the corresponding RIS-UE and RIS-AP beam indices may be stored in a codebook 111 on RIS 96 (FIG. 9). The RIS-AP beam indices and the RIS-UE beam indices may each be labeled with a respective RIS beam index m_{RIS} and there may be M_{RIS} total RIS beam indices in codebook 111 (e.g., where M_{RIS} includes both the RIS-AP beam indices and the RIS-UE beam indices). Codebook 111 may be hardcoded and/or soft-coded on RIS 96 (e.g., codebook 111 may include a table, database, register, or other data object stored on RIS 96).

The AP-RIS configuration may include an optimal AP beam that is oriented towards RIS 96 (e.g., the corresponding AP beam index may and/or settings for phased antenna array 88′). Establishing the AP-RIS configuration may involve identifying/finding the optimal AP beam and an optimal RIS-AP beam that points back towards AP 6. Once the AP-RIS configuration has been established, AP 6 has knowledge of the relative position and orientation of RIS 96 with respect to AP 6. AP 6 can then use this information to know how to direct the AP beam and how to control RIS 96 to reflect THF signals at different angles between AP 6 and UE device 10 via RIS 96.

To generate the AP-RIS configuration, AP 6 may use the control RAT to coordinate signal beam searches at both AP 6 and RIS 96. The searches may cover the field-of-view (FOV) of AP 6, which is covered by the AP beams identified by codebook 113 of FIG. 9 (e.g., a codebook specifying MAP total AP signal beams each identified by a corresponding AP signal beam index m_{AP}). The searches may also cover the FOV of RIS 96, which is covered by the RIS beams identified by codebook 111 of FIG. 9 (e.g., a codebook specifying M_{RIS} total RIS beams each identified by a corresponding RIS beam index m_{RIS}). The RIS beams may include both RIS-AP beams and RIS-UE beams (e.g., where the total number of RIS beams M_{RIS} includes both the total number of RIS-UE beams and the total number of RIS-AP beams). The search may involve a hierarchal beam sweep with an outer loop performed over some or all of the M_{RIS} RIS beams (e.g., over the RIS-AP beams of RIS 96) and with an inner loop performed over the M_{AP} AP signal beams

For example, AP 6 may use control RAT 116 to instruct RIS 96 to form an initial RIS beam from the set of formable RIS beams (e.g., an initial RIS-AP beam from the set of formable RIS-AP beams) Control circuitry on RIS 96 may then adjust antenna elements 100 (e.g., the UTC PDs in antenna elements 100, varactor diodes coupled to antenna elements 100, phase shifters coupled to antenna elements 100, amplifiers coupled to antenna elements 100, impedance matching circuitry coupled to antenna elements 100, etc.) to exhibit an initial set of settings (e.g., beamforming coefficients, impedances, phases, magnitudes, etc.) across array 98. The initial set of settings may correspond to the initial RIS beam (e.g., the initial RIS-AP beam) from the set of RIS beams formable by RIS 96 (e.g., from the set of RIS-AP beams identified by codebook 111 of FIG. 9) that RIS 96 is instructed by AP 6 to form via the control RAT. Control circuitry 14′ (FIG. 1) may then program phased antenna array 88′ on AP 6 to form an initial AP beam. The initial AP beam may be an initial AP beam from the set of AP beams formable by AP 6 (e.g., from the set of AP beams identified by codebook 113 of FIG. 9).

AP 6 may then use phased antenna array 88′ to transmit THF signals 32 over the current (initial) AP beam. The THF signals 32 may be transmitted using a radar waveform (e.g., without wireless data modulated thereon). The radar waveform may be a chirp signal, a ramp signal, a sawtooth signal, an FMCW waveform, an OTFS waveform, an OFDM waveform, or any other desired waveform for performing spatial ranging operations using THF signals 32 (e.g., radar operations), as examples. The transmitted THF signals 32 may propagate through environment 90 (e.g., within the initial AP beam). None, some, or all of the THF signals 32 (the radar waveform) may reflect off RIS 96. Depending on the current setting for antenna elements 100 on RIS 96 (e.g., the current RIS-AP beam), none, some, or all of the reflected signals may be reflected back towards AP 6. Phased antenna array 88′ on AP 6 may receive THF signals over the current (initial) AP beam. The received THF signals may include none, some, or all of the transmitted radar waveform that has reflected off of RIS 96. AP 6 may gather wireless performance metric data (e.g., may measure wireless performance metric data) associated with the amount of the reflected THF signals the AP has received from RIS 96 over the current AP and RIS beams (e.g., AP 6 may process the received signal to identify the reflected radar waveform in the received signal). The wireless performance metric data may include received signal strength values, error rate values, received power level values, signal-to-noise ratio values, and/or any other desired wireless performance metric data values indicative of the amount of the transmitted radar waveform reflected off of RIS 96 and received back at AP 6. AP 6 may store the wireless performance metric data as well as information identifying the current AP signal beam and RIS signal beam (e.g., settings for antenna elements 100) that were in use while the wireless performance metric data was measured.

If AP beams in the set of formable AP beams (e.g., codebook 113) remain, AP 6 may increment the AP beam and may re-configure (update) phased antenna array 88′ to form the incremented AP beam as the current AP beam. The incremented (current) AP beam may be the next formable AP beam from codebook 113 or, if desired, the inner loop may perform a coarse beam search and then a fine beam search over the AP beams (e.g., a hierarchical AP beam search). Processing may sweep through AP beams until no AP beams remain for processing. When no AP beams remain, AP 6 may use control RAT 116 to instruct RIS 96 to increment the RIS beam (e.g., to set an incremented RIS-AP beam as the current RIS beam). If RIS beams (e.g., RIS-AP beams) remain in the set of formable RIS beams (e.g., codebook 111), the incremented (current) RIS beam may be the next formable RIS beam (e.g., the next RIS-AP beam) from codebook 111 or, if desired, the outer loop may perform a coarse beam search and then a fine beam search over the RIS-AP beams (e.g., a hierarchical RIS beam search). RIS 96 may reconfigure antenna elements 100 to form the incremented (current) RIS beam (e.g., by changing the setting of antenna elements 100 across array 98 according to codebook 111). Processing may then continue to sweep through each of the AP beams while RIS 96 is set to the current RIS beam (e.g., the current RIS-AP beam) and may continue to increment the RIS beam until no RIS beams remain to search. In this way, AP 6 may gather wireless performance metric data for each combination of RIS beams and AP beams.

When no RIS beams remain to search, control circuitry 14 on AP 6 may identify an optimal AP signal beam from the set of searched AP signal beams and may identify an optimal RIS-AP beam from the set of searched RIS beams based on the stored wireless performance metric data. The optimal AP beam and the optimal RIS-AP beam may, for example, be the beams for which the peak wireless performance metric data was gathered, beams for which wireless performance metric data within a range of acceptable wireless performance metric data values was gathered, beams for which wireless performance metric data that exceeds a threshold value was gathered, etc. The optimal AP beam corresponds to the AP beam that is oriented towards RIS 96. The optimal RIS-AP beam corresponds to the RIS beam (e.g., the reflected AP beam) that is oriented back towards AP 6.

AP 6 may then configure itself and RIS 96 to implement the AP-RIS configuration. For example, AP 6 may configure phased antenna array 88′ to form the optimal AP beam and/or may use the control RAT to configure RIS 96 to form the optimal RIS-AP beam. Control circuitry 14′ on AP 6 may also identify (e.g., characterize, compute, estimate, calculate, determine, generate, produce, etc.) the position and/or orientation of RIS 96 relative to AP 6 based on the optimal beams. The position and/or orientation may include information in as many as six degrees of freedom (e.g., as shown by arrows X, Y, Z, 104, 106, and 108 of FIG. 8). Control circuitry 14′ may identify the distance between AP 6 and RIS 96 using time-of-flight of the transmitted and reflected radar waveforms. Control circuitry 14′ may identify the position and/or orientation in one or more of the other degrees of freedom using the known position and geometry of AP 6 and RIS 96 (e.g., as identified by RIS 96 in the capability identifiers or as predetermined and known in advance by AP 6) in combination with knowledge of the optimal AP beam and/or the optimal RIS-AP beam. For example, since the optimal AP beam points towards RIS 96 and the optimal RIS-AP beam points towards AP 6, and the codebooks give the beam pointing direction associated with the optimal beams (e.g., each beam is oriented in a known/predetermined beam pointing direction), control circuitry 14′ may deduce the relative position and orientation of RIS 96 simply from the knowledge of which beams are the optimal beams.

At this point, RIS 96 is completely discovered and known to AP 6 by both control RAT 116 and data RAT 118. RIS 96 has knowledge of the relative position and orientation of RIS 96. As AP 6 and RIS 96 are generally fixed in place and do not move with respect to each other, it is assumed that the AP-RIS configuration is fixed upon discovery by AP 6. As such, the RIS-AP beam and the AP beam may remain fixed during the remaining operations of FIG. 13 (e.g., the remaining operations of FIG. 13 may be used to identify/update the RIS-UE configuration). This is merely illustrative and, if AP 6 or RIS 96 moves over time, one or more of operations 150-154 132 may be repeated (e.g., processing may loop back to operations 150-154 as needed). RIS 96 and AP 6 may then wait for a UE device 10 to become available for communication. Once a UE device 10 becomes available for communication with AP 6 (e.g., when UE device 10 powers on within the vicinity of AP 6 and/or RIS 96 or moves to a location within communications range of AP 6 and/or RIS 96), processing may proceed to operation 156 and the UE device may attempt to communicate with AP 6 (e.g., to communicate with the rest of the network via AP 6).

At operation 156, AP 6 and UE device 10 may attempt to establish a wireless link over data RAT 118 (e.g., to support high data rate wireless data transfer between UE device 10 and the rest of the network) without reflection via RIS 96 (e.g., over LOS path 92 of FIG. 8). AP 6 may sweep over AP beams and/or UE device 10 may sweep over UE beams while AP 6 and/or UE device 10 transmits reference signals over data RAT 118. AP 6 and UE device 10 may exchange control messages over control RAT 116 to synchronize and coordinate the sweep over the AP beams and/or UE beams AP 6 and/or UE device 10 may gather wireless performance metric data from the data RAT at each combination of UE beam and AP beam in the sweep. If desired, AP 6 and UE device 10 may use control RAT 116 to exchange the wireless performance metric data. AP 6 and/or UE device 10 may use the wireless performance metric data to identify (e.g., discover, generate, etc.) an optimal AP beam that is suitable for data RAT communications between AP 6 and UE device 10 without reflection off RIS 96 (referred to herein as an AP serving beam) and an optimal UE beam that is suitable for data RAT communications between AP 6 and UE device 10 without reflection off RIS 96 (referred to herein as a UE serving beam). AP 6 and UE device 10 may exchange information identifying the optimal AP beam and/or optimal UE beam over control RAT 116.

In some cases, AP 6 and UE device 10 may be unable to discover an AP serving beam and UE serving beam. Such situations may occur when object 94 blocks LOS path 92 (FIG. 8) or whenever the radio-frequency propagation characteristics between AP 6 and UE device 10 are too weak to support a direct data RAT link between AP 6 and UE device 10. If an AP serving beam and a UE serving beam are discovered (e.g., within a predetermined time period), processing may proceed to operation 160 via path 158.

At operation 160, UE device 10 and AP 6 may begin to convey wireless communications data using THF signals 32 that are transmitted over data RAT 118 while UE device 10 forms the UE serving beam and while AP 6 forms the AP serving beam (e.g., without reflecting THF signals 32 off RIS 96).

At operation 162, UE device 10 and AP 6 may use control RAT 116 to perform and coordinate tracking on UE device 10 to update the AP serving beam and/or the UE serving beam as UE device 10 moves or rotates over time. Control RAT 116 may, for example, be used to coordinate sweeps over the AP beam and/or sweeps over the UE beam (using data RAT 118) periodically or on-demand to ensure that UE device 10 is able to continue data RAT communications with AP 6. The sweeps may be performed to ensure that other AP beams or UE beams are selected and used as serving beams when they offer superior wireless performance than the previous serving beams If desired, the sweeps may be performed based on sensor data gathered at UE device 10 (e.g., to select a subset of the AP beams and/or a subset of the UE beams to search over, thereby requiring less time than performing a full sweep over all AP beams and all UE beams) UE device 10 and AP 6 may continue to exchange wireless data using THF signals until there is a tracking failure. A tracking failure may occur when AP 6 is no longer able to track UE device 10 (e.g., with its AP beams) or when UE device 10 is no longer able to track AP 6 (e.g., with its UE beams). Such a tracking failure may occur when object 94 blocks LOS path 92 between AP 6 and UE device 10 (FIG. 8), when UE device 10 powers off, when UE device 10 leaves the vicinity of AP 6, or when the radio-frequency propagation characteristics between UE device 10 and AP 6 are otherwise inadequate. When a tracking failure occurs, processing may proceed to operation 168. Processing may alternatively loop back to operation 154 when UE device 10 powers off or leaves the vicinity.

If no AP serving beam or UE serving beam are discovered (e.g., within a predetermined time period) while processing operation 156, processing may proceed from operation 156 to operation 166 via path 164. At operation 166, AP 6 and UE device 10 may use control RAT 116 to convey control information. The control information may include information identifying the presence of UE device 10 to AP 6 and/or control information identifying the presence of AP 6 to UE device 10. The control information may include identifiers and/or capability identifiers. Since control RAT 116 typically does not require a LOS path between UE device 10 and AP 6, control RAT 116 may allow AP 6 to discover UE device 10 when AP 6 is otherwise unable to discover UE device 10 using data RAT 118. Processing may then proceed to operation 168.

At operation 168, AP 6, RIS 96, and/or UE device 10 may use control RAT 116 to coordinate use of data RAT 118 to sweep RIS 96 over its RIS-UE beams and/or to sweep UE device 10 over its UE beams In other words, AP 6 and UE device 10 may attempt to establish a wireless link over data RAT 118 (e.g., to support high data rate wireless data transfer between UE device 10 and the rest of the network) via reflection off RIS 96.

AP 6 and/or UE device 10 may use control RAT 116 to instruct RIS 96 to sweep over RIS-UE beams UE device 10 may also sweep over UE beams AP 6 or UE device 10 may transmit reference signals over data RAT 118 while RIS 96 sweeps over RIS-UE beams and UE device 10 sweeps over UE beams RIS 96 may concurrently form its RIS-AP serving beam and AP 6 may concurrently form its AP serving beam (e.g., under the assumption that AP 6 and RIS 96 are at fixed locations). UE device 10 or AP 6 may receive and measure the transmitted reference signals and may generate wireless performance metric data from the reference signals. If desired, control RAT 116 may be used to exchange wireless performance metric data. UE device 10 or AP 6 may select a RIS-UE serving beam and a UE serving beam based on the wireless performance metric data (e.g., where the RIS-UE serving beam is the RIS-UE serving beam from the sweep and the UE serving beam is the UE serving beam from the sweep that exhibited peak wireless performance metric data values or otherwise acceptable wireless performance metric data values). AP 6 and UE device 10 may use control RAT 116 to convey information identifying the RIS-UE serving beam and/or the UE serving beam. Operation 168 may be repeated until RIS-UE and UE serving beams are found. If desired, processing may loop back to any of operations 150-166 if RIS-UE and UE serving beams are not found within a predetermined time period.

Once a RIS-UE serving beam and a UE serving beam have been found, processing may proceed to operation 170. At operation 170, AP 6 and/or UE device 10 may use control RAT 116 to configure RIS 96 to form the RIS-UE serving beam (e.g., by configuring the antenna elements on RIS 96 using corresponding beamforming coefficients, impedances, etc.). Once formed, the RIS-UE serving beam UE device 10 may also form the UE serving beam (or AP 6 may use the control RAT to instruct UE device 10 to form the UE serving beam). The RIS-UE serving beam may be formed by RIS 96 and may have a beam pointing direction oriented towards UE device 10. Similarly, the UE serving beam may be formed by UE device 10 and may have a beam pointing direction oriented towards RIS 96. UE device 10 and AP 6 may then begin to convey wireless communications data using THF signals 32 that are transmitted over data RAT 118 while UE device 10 forms the UE serving beam, while AP 6 forms the AP serving beam, while the RIS forms the RIS-AP serving beam, and while the RIS forms the RIS-UE serving beam. In this way, RIS 96 may reflect THF signals 32 between UE device 10 and AP 6.

At operation 172, AP 6 and UE device 10 may use control RAT 116 to perform and coordinate tracking on UE device 10 to update the RIS-UE serving beam and/or the UE serving beam as UE device 10 moves or rotates over time (e.g., under the assumption that the position of AP 6 and RIS 96 remain fixed). If desired, the tracking may also update the RIS-AP serving beam and/or the AP serving beam (e.g., when AP 6 or RIS 96 do not remain at fixed positions).

Control RAT 116 may, for example, be used to coordinate sweeps over the UE beam and/or sweeps over the RIS-UE beam (using data RAT 118) periodically or on-demand to ensure that UE device 10 is able to continue data RAT communications with AP 6 via RIS 96. The sweeps may be performed to ensure that other RIS-UE beams or UE beams are selected and used as serving beams when they offer superior wireless performance than the previous serving beams. If desired, the sweeps may be performed based on sensor data gathered at UE device 10 (e.g., to select a subset of the RIS-UE beams and/or a subset of the UE beams to search over, thereby requiring less time than performing a full sweep over all RIS-UE beams and all UE beams). UE device 10 and AP 6 may continue to exchange wireless data using THF signals until there is a tracking failure. When a tracking failure occurs, processing may loop back to operation 156 via path 174. Processing may alternatively loop back to operation 154 when UE device 10 powers off or leaves the vicinity. Processing may alternatively loop back to operation 154 when UE device 10 powers off or leaves the vicinity.

During tracking of UE device 10 (e.g., at operation 172), AP 6 may transmit reference signals to RIS 96. RIS 96 may reflect the reference signals incident within its active RIS-AP beam onto its active RIS-UE beam (e.g., the serving RIS-UE beam) and towards UE device 10. One or more sensors on UE device 10 may generate sensor data. The sensor data may be motion sensor data generated by a motion sensor on UE device 10 (e.g., inertial measurement unit sensor data, orientation sensor data, compass data, gyroscope data, accelerometer data, etc.), light sensor data (e.g., infrared and/or ambient light sensor data), image sensor data (e.g., camera data, light detection and ranging (lidar) data, etc.), proximity sensor data, touch sensor data, radio-frequency sensor data (e.g., RADAR data or other spatial ranging sensor data, UWB angle-of-arrival and/or time-of-flight data, wireless performance metric data characterizing the radio-frequency performance of one or more receivers and/or transmitters in UE device 10 such as wireless performance metric data characterizing receipt of the reference signals), and/or any other desired sensor data.

If desired, control circuitry 14 on UE device 10 may generate (e.g., select, compute, calculate, identify, produce, etc.) a set of tracking beams based on the sensor data and/or the current UE beam, RIS beams (e.g., the current RIS-UE beam and/or RIS-AP beam), and/or AP beam. The set of tracking beams may include a set of RIS-UE beams and a set of UE beams The tracking beams are signal beams over which RIS 96 and UE device 10 will sweep to maintain THF communications via RIS 96 despite the movement/rotation of UE device 10. Each signal beam in the set of tracking beams may therefore sometimes be referred to herein as a tracking beam. The set of RIS-UE beams in the set of tracking beams may be a subset of the total number of RIS-UE beams formable by RIS 96 (e.g., where the total number of formable RIS-UE beams is itself a subset of the M_{RIS} total RIS beams formable by RIS 96 and identified by the codebook for RIS 96). The set of UE beams in the set of tracking beams may be a subset of the M_{UE} total UE beams formable by UE device 10. As the set tracking beams only include subsets of the total RIS-UE beams formable by RIS 96 and the total UE beams formable by UE device 10, sweeping over the set of tracking beams rather than performing a full sweep over all signal beams formable by RIS 96 and UE device 10 allows THF communications to be maintained with minimal latency and disruption. UE device 10 may use the sensor data and/or information about the current signal beam(s) to identify which signal beams are included in the set of tracking beams (e.g., RIS-UE signal beams that are likely to overlap UE device 10 given its rotation/motion).

UE device 10 or AP 6 may use the control RAT to control (program) RIS 96 to sweep over the RIS-UE beams included in the set of tracking beams. UE device 10 may additionally or alternatively use control signals to control (program) its phased antenna array 88 to sweep over the UE beams included in the set of tracking beams AP 6 may continue to transmit reference signals during each of these sweeps. UE device 10 may identify (e.g., generate, produce, select, etc.) serving beams from the set of tracking beams to use for subsequent THF communications. The serving beams may include a RIS-UE signal beam and a UE signal beam that allow RIS 96 to successfully relay THF signals between AP 6 and UE device 10 given the rotation/motion of UE device 10. UE device 10 may gather sensor data during the sweep(s) performed at operation 180 to identify the serving beams For example, UE device 10 may gather wireless performance metric information (e.g., received signal strength data, signal-to-noise ratio data, error rate data such as bit error rate (BER) data, power level data such as reference symbol received power (RSRP) data, etc.) during the sweep(s) over the set of tracking beams. UE device 10 may identify (select) the tracking beam(s) from the sweep(s) that produced peak wireless performance metric information as the serving beam(s) (e.g., because peak wireless performance metric information is indicative of a RIS-UE beam that overlaps the new location/orientation of UE device 10 and a UE beam that points towards RIS 96 at the new location/orientation of UE device 10). Once the serving beam(s) have been found, the serving beam(s) may be used to convey THF signals between AP 6 and UE device 10 via RIS 96 until the signal beam(s) need to be updated or until there is a tracking failure.

The example of FIG. 13 is merely illustrative. In general, the control RAT functions and data RAT functions may be split in other ways. Other procedures may be used to discover, configure, and track UE device 10 over control RAT 116. Additional operations may be added to perform beam sweeps over AP beams and/or RIS-AP beams periodically or on-demand (e.g., when AP 6 and/or RIS 96 are not at fixed locations). The operations of FIG. 13 may be performed in other orders. Two or more of the operations of FIG. 13 may be performed concurrently. If desired, the operations described in FIG. 13 as being performed by AP 6 may instead be performed by UE device 10 while the operations described in FIG. 13 as being performed by UE device 10 may be performed by AP 6.

UE device 10 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users. The optical components described herein (e.g., MZM modulator(s), waveguide(s), phase shifter(s), UTC PD(s), etc.) may be implemented in plasmonics technology if desired.

The methods and operations described above in connection with FIGS. 1-13 may be performed by the components of UE device 10, RIS 96, and/or AP 6 using software, firmware, and/or hardware (e.g., dedicated circuitry or hardware). Software code for performing these operations may be stored on non-transitory computer readable storage media (e.g., tangible computer readable storage media) stored on one or more of the components of UE device 10, RIS 96, and/or AP 6. The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of UE device 10, RIS 96, and/or AP 6. The processing circuitry may include microprocessors, central processing units (CPUs), application-specific integrated circuits with processing circuitry, or other processing circuitry.

The foregoing is merely illustrative and various modifications can be made to the described embodiments. The foregoing embodiments may be implemented individually or in any combination.

What is claimed is:

1. A method of operating a wireless access point to communicate with a user equipment (UE) device via a reconfigurable intelligent surface (RIS), the RIS having a first array of antenna elements that is configurable to exhibit different sets of reflection coefficients, the method comprising:
transmitting, using a transmitter and a first radio access technology (RAT), an instruction to the RIS that configures the first array of antenna elements at the RIS to exhibit a selected set of reflection coefficients from the different sets of reflection coefficients; and
conveying, using a second array of antenna elements at the wireless access point and a second RAT that is different from the first RAT, radio-frequency signals with the UE device via reflection off the RIS concurrent with the first array of antenna elements exhibiting the selected set of reflection coefficients.

2. The method of claim 1, further comprising:
receiving, using a receiver and the first RAT, an identifier from the RIS.

3. The method of claim 2, wherein the identifier identifies at least one capability of the RIS in reflecting the radio-frequency signals using the second RAT.

4. The method of claim 2, further comprising:
receiving, using the receiver and the first RAT, an additional identifier from the UE device.

5. The method of claim 1, further comprising:
synchronizing, using the first RAT, a timing between the RIS, the wireless access point, and the UE device.

6. The method of claim 1, further comprising:
transmitting, using the transmitter and the first RAT, an additional instruction that configures the RIS to sweep the first array of antenna elements over the different sets of reflection coefficients;
transmitting, using the second RAT and the second set of antenna elements, a radar signal to the RIS concurrent with the first array of antenna elements sweeping over the set of signal beams; and
generating, at one or more processors, wireless performance metric data from a reflected version of the radar signal received at the wireless access point.

7. The method of claim 6, wherein the selected set of reflection coefficients from the different sets of reflection coefficients is selected based on the wireless performance metric data.

8. The method of claim 1, further comprising:
writing, using the transmitter and the first RAT, beamforming coefficients to a codebook on the RIS.

9. The method of claim 1, further comprising:
transmitting, using the transmitter and the first RAT, an additional instruction to the RIS that configures the first array of antenna elements to switch from exhibiting the selected set of reflection coefficients to exhibiting an additional selected set of reflection coefficients from the different sets of reflection coefficients; and
transmitting, using the second set of antenna elements and the second RAT, the radio-frequency signals to an additional UE device via reflection off the RIS concurrent with the first array of antenna elements exhibiting the additional selected set of reflection coefficients.

10. The method of claim 1, further comprising:
coordinating, using the first RAT, beam tracking of the UE device over the second RAT.

11. A method of operating a user equipment (UE) device to communicate with a wireless access point via a reconfigurable intelligent surface (RIS), the RIS having a first array of antenna elements and the method comprising:
transmitting, using a transmitter and a first radio access technology (RAT), a control signal that configures a response of the RIS in using the first array of antenna elements to reflect electromagnetic energy; and
conveying, using a second array of antenna elements at the UE device and a second RAT that is different from the first RAT, radio-frequency signals with the wireless access point via reflection off the RIS.

12. The method of claim 11, wherein the control signal configures the first array of antenna elements to form a selected signal beam from a set of signal beams formable by the first array of antenna elements and the second array of antenna elements is configured to transmit the radio-frequency signals concurrent with the first array of antenna elements forming the selected signal beam.

13. The method of claim 12, further comprising:
receiving, with the second array of antenna elements, a reference signal transmitted by the wireless access point using the second RAT; and
generating, at one or more processors, wireless performance metric data based on the received reference signal, wherein the selected signal beam is selected from the set of signal beams based on the wireless performance metric data.

14. The method of claim 11, further comprising:
sweeping the second array of antenna elements over a set of signal beams while using the second RAT to discover the wireless access point; and
using the first RAT to discover the wireless access point when the UE device is unable to discover the wireless access point using the second RAT.

15. A method of operating a reconfigurable intelligent surface (RIS) to reflect radio-frequency signals between a first electronic device and a second electronic device, the method comprising:
receiving, using a receiver and a first radio access technology (RAT), a control signal transmitted by the first electronic device;
configuring, using one or more processors, an array of antenna elements to exhibit a set of reflection coefficients based on the control signal; and
reflecting, using the array of antenna elements, radio-frequency signals between the first electronic device and the second electronic device while the array of antenna elements exhibits the set of reflection coefficients, the radio-frequency signals being of a second RAT that is different from the first RAT.

16. The method of claim 15, wherein the radio-frequency signals are at a frequency greater than or equal to 100 GHz.

17. The method of claim 16, wherein the first RAT comprises Wi-Fi.

18. The method of claim 16, wherein the first RAT comprises ultra-wideband (UWB).

19. The method of claim 16, wherein the first RAT comprises Bluetooth.

20. The method of claim 16, wherein the first RAT comprises a cellular telephone RAT.
